(19) United States
(12) Patent Application Publication
(10) Pub. No.: US 2024/0237648 A1
(43) Pub. Date: Jul. 18, 2024

(54) SYNERGISTIC OIL DISPERSION AGROCHEMICAL COMPOSITION CONTAINING SPINETORAM

(71) Applicant: RAJDHANI PETROCHEMICALS PRIVATE LIMITED, Ahmedabad, Gujarat (IN)

(72) Inventors: Dipakkumar PATEL, Ahmedabad, Gujarat (IN); Kenal V. SHAH, Ahmedabad, Gujarat (IN); Bhavesh V. SHAH, Ahmedabad, Gujarat (IN); Kawarlal DABHODIA, Ahmedabad, Gujarat (IN)

(21) Appl. No.: 18/563,891

(22) PCT Filed: May 27, 2022
(86) PCT No.: PCT/IN2022/050496

§ 371 Date: Nov. 23, 2023

(30) Foreign Application Priority Data
May 27, 2021 (IN) 202121023694

(51) Int. Cl. A01N 43/22; A01N 25/04; A01N 37/22; A01N 43/40; A01N 43/56; A01N 43/58; A01N 43/76; A01N 43/78; A01N 43/80; A01N 43/90; A01N 47/30; A01N 51/00; A01N 53/00; A01P 7/04

(52) U.S. Cl. CPC A01N 43/22; A01N 25/04; A01N 37/22; A01N 43/40; A01N 43/56; A01N 43/58; A01N 43/76; A01N 43/78; A01N 43/80; A01N 43/90; A01N 47/30; A01N 51/00; A01N 53/00; A01P 7/04

(57) ABSTRACT

Synergistic oil dispersion agrochemical composition containing Spinetoram. More particularly the present invention relates to a synergistic Oil Dispersion agrochemical composition comprising bioactive amount of (A) Spinetoram; and (B) at least one more of active ingredients selected from class of an insecticides; or a fungicides; or a plant health additive; or combination thereof. The present invention further relates to selection of suitable formulation excipients, process of preparation of the said oil dispersion formulation and its application in the field of agriculture.

### FIELD OF INVENTION

The present invention relates to a synergistic agrochemical composition. More particularly the present invention relates to a synergistic Oil Dispersion composition comprising bioactive amount of (A) Spinetoram; and (B) at least one more of active ingredients selected from class of an insecticide; or a fungicides; or a plant health additive; or combination thereof. The present invention further relates to selection of suitable formulation excipients, process of preparation of the said oil dispersion formulation and its application in the field of agriculture.

### BACKGROUND OF THE INVENTION

These days cultivation of crops and agriculture in general is cost intensive. Receiving a high yield from the cultivated crops is a key. Hence, to achieve higher yield, protecting crops from pests and diseases is vital. Hence the most effective way to control crop pests and diseases is the application of pesticides in accordance with the appropriate management practices with proper formulation thereof.

Treating plants with such a pesticides and plant health additives or combination thereof in appropriate formulation helps to reduce the crops/plants damage. Another advantage of treating the plants with the said combination is the improvement in plant growth overall plant health and increase in the crop yield.

Various kinds of agrochemical formulations are developed based upon active ingredients and scope of application thereof. Pesticides for agriculture purpose are available both in the pure form and as well as incorporated into agrochemical formulations, which typically comprise one or more active ingredients (AIs) and additional excipients substances that enhance the effects and facilitate the application thereof, such as carriers, adjuvants or additives. These formulations can be directly applied onto the crops or, more commonly, are applied after being diluted and the spray mixture formed. The formulation type to be used is primarily defined on the basis of physicochemical characteristics of the AI(s) and can be: soluble concentrate (SL), emulsifiable concentrate (EC), emulsion in water (EW), suspension concentrate (SC), suspo-emulsion (SE), micro-emulsion (ME), oil dispersion (OD) or suspension concentrate (SC), dispersible concentrate (DC), capsule suspension (CS), dispersible granules (WG), wettable powder (WP) and others.

The various types of agrochemical formulations are the result of the existence of a large variety of AIs of different chemical natures. For example, a water soluble AI can be easily included into a water based SL while a high melting, water insoluble AI is commonly found in the form of a EC (Emulsifiable concentrate). For this reason, agrochemical formulations are distinct and can contain different inert components.

In recent years, OD (Oil Dispersion) formulations have been the subject of studies by companies and formulators because of their advantages with respect to the agronomic performance in the field as compared with conventional formulations. Active ingredients (AIs) formulated in different types of formulations usually exhibit different physicochemical characteristics based on type of formulation they are incorporated in. The different performance between them is due to the fact that ODs already contain in their composition oil, such as a mineral or vegetable oil, and emulsifiers, which can act as penetration adjuvants when applied in the field. Penetration adjuvants aid in the absorption of AIs by the plant and, in the case of some conventional formulations, they are used in association with the formulation in the spray mixture, ensuring agronomical effectiveness of the AI. Thus, OD formulations can be deemed “adjuvanted” formulations and do not require additional associated adjuvants to be applied in the field.

Though OD formulation is called as adjuvanted formulation it still requires various adjuvants along with formulation excipients. OD formulation presents several challenges in the process of manufacturing and developing stable and effective formulation with choice of proper formulation excipient or adjuvants. To obtain a good and stable formulation over time, optimal formulation additives are required in addition to optimum processes. There were several development and research done in the filed-field of formulation development of Oil Dispersion (OD) formulation. Dispersion and activation of active ingredients is the key to the stability of the formulation over time. Solvents or carrier used as a petroleum based or the aromatic solvent we replaced by the solvents in the form of vegetable oils. Vegetable oils application as a formulation excipients in OD formulation further have their own challenges for stable formulation due to stability issue associated with vegetable oil used and corresponding active ingredient. Although various research has been done in formulation development it has got many draw backs as having high dose of active ingredients and thereby maximizing the pesticidal load into the environment. Many OD formulations has less thermal and chemical stability over a broad range of conditions; increases the toxicity hazards to the applicators and thereby decreasing the safety of applicators at the time of handling and spraying the pesticides. Further some OD formulation with less suitable formulation excipients may lead to have less leaf penetration of spray droplets, and increases evaporation loss and minimize the absorption of active ingredients.

Therefore there is further need and scope in the formulation development of the OD formulation comprising one or more active ingredients with better stability profile and increases the synergistic effect of the active ingredients, reduces the toxicity with less introduction of toxic material in environment, which may reduce the dose of the pesticides and eventually produce less chemicals in environment, with better safety profile for contact pesticides.

AU2010220503B2 relates to a formulation of agrochemical compounds in oil suspension or oil dispersion. It further relates to a compound Imidacloprid, Thiamethoxam, Thiacloprid, Nitenpyram, Acetamiprid, Clothianidin and Dinetofuran and derivatives thereof with nAChR binding ability are successfully formulated in oil suspension with the use of certain copolymeric anionic fatty-acid based dispersants, sorbitan derivatives, ionic surfactants, other non-ionic surfactants and inorganic polyvalent cationic salt dispersed in the oil. The compound further comprises Spinetoram along with various agrochemical compound to form Oil dispersion formulation.

US20110160054A1 relates to a Pesticidal mixtures comprising Spinetoram and cyanosulfoximine compounds. The said patent further relates to new pesticidal mixtures of active ingredients having synergistically enhanced action. The said active ingredients comprise cyanosulfoximine compounds, spinetoram and optionally other pesticidal effective compounds. The invention relates further also to methods and use of these mixtures for combating insects, arachnids or nematodes in and on plants and animals, and for protecting such plants and animals being infested with pests and also for protecting seeds. The said mixture of pesticide further comprises one or more insecticides and/or one or more fungicides as active ingredient.

U.S. Ser. No. 10/542,754B2 relates to a pesticidal composition that comprises a synergistically effective amount of Spinetoram and methoxyfenozide. The pesticidal composition comprises methoxyfenozide in an amount of at least three parts by weight per one part by weight of spinetoram. The said pesticidal composition further comprises an additive selected from a surfactant, a stabilizer, an emetic agent, a disintegrating agent, an antifoaming agent, a wetting agent, a dispersing agent, a binding agent, dye, filler, or combinations thereof.

CN107125260B relates to an insecticidal composition containing spinetoram and deltamethrin, a preparation method and application thereof, wherein the content of spinetoram in the insecticidal composition is 10-35 wt %, and the content of deltamethrin in the insecticidal composition is 5-15 wt %. the said composition further relates to an insecticidal composition obtained by compounding spinetoram and deltamethrin, and also relates to a dispersible oil suspending agent formulation of the insecticidal composition containing spinetoram and deltamethrin, a preparation method and application thereof, belonging to the technical field of pesticides.

CN103098816A relates to pesticidal combination comprising two active ingredients indoxacarb and spinetoram and additives, wherein the weight ratio of indoxacarb to spinetoram is (30:1)-(1:30), and the weight sum of indoxacarb and spinetoram accounts for 2% to 85% by weight of the insecticidal composition. The said composition further comprises missible oil, microemulsion, suspending agent, wetting powder, aqueous emulsion or water dispersible granules.

There is however a need for improvement of these combinations. Single active combination used over a long period of time has resulted in resistance. With the onset of resistance to certain pests, there is a need in the art for a combination of actives that decrease the chances of resistance and improves the spectrum of insect-pests and diseases control.

In general use, the pesticide actives are used in the form of a dilute aqueous composition because it can attain a good interaction with the target organism, such as plants, insect-pests and diseases. However, most active pesticide compounds that are used as pesticides are only sparingly or insoluble in water. The low solubility of such compounds present the challenges and difficulties to formulator in formulating pesticide compounds in stable formulations that can be easily stored for a long time and which can still have a high stability and effective activity until end use. This problem especially occurs and may get worsen if more than one active compound is present in the mixture.

Therefore there is further need to formulate the novel OD formulation which increases the synergistic activities between active ingredients by using the appropriate formulation excipients; enhance the duration of control of insect-pests, and mites, fungal and bacterial diseases; reduce the doses of active ingredients and thereby minimizing the pesticidal load into the environment; has thermal and chemical stability over a broad range of conditions; reduces the toxicity hazards to the applicators, i.e. improves the safety of applicators at the time of handling and spraying the pesticides; and improves leaf penetration of spray droplets, retard evaporation loss and enhance the absorption of active ingredients.

There is however a need for improvement of OD formulations. Many a times it has been found that single or combination of active ingredients requires a high loading dose for the better results. Further this will create a higher loading of the pesticides in the environment. Further many of the OD formulation recipe is prone to lose stability when exposed to the higher temperature. In addition there are higher chances of formulation applied gets evaporated resulting in the loss of the active ingredients before penetration.

Therefore, one object of the present invention is to provide improved combinations of (A) Spinetoram; and (B) at least one more of active ingredients selected from class of insecticides or fungicides or plant health additive or combination thereof for the control of insect-pest. Another object of the present invention is to provide a method and a composition for controlling insect pests and diseases (fungal diseases and bacterial diseases) on a full grown plant.

Yet another object of the present invention is to provide improved combinations of (A) Spinetoram; and (B) at least one more of active ingredients selected from class of insecticides; or fungicides; or plant health additive; or combination thereof that promote plant health and increase plant yield in the field.

Further object of the present invention is to provide suitable formulation excipients for the present Oil Dispersion formulation in order to produce stable and synergistic formulation.

Another object of the present invention is to provide a method and a composition for the OD formulation.

Embodiment of the present invention can ameliorate one or more of the above mentioned problems.

Inventors of the present invention have surprisingly found that the novel synergistic mixture of OD formulation for plant treatment comprising of (A) Spinetoram; and (B) any one of active ingredients selected from class of insecticides or fungicides or plant health additive or combination thereof can provide solution to the above mentioned problems.

### SUMMARY OF INVENTION

Therefore an aspect of the present invention provides a synergistic agrochemical Oil Dispersion (OD) composition comprising bioactive amount of (A) Spinetoram; and (B) at least one more of active ingredients selected from class of insecticides or fungicides or plant health additive or combination thereof; along with formulation excipients.

More particularly the aspect of the present invention is to provide the a synergistic agrochemical Oil Dispersion (OD) composition comprising possible combinations of Spinetoram+Insecticide; or Spinetoram+Insecticide A+Insecticide B; or Spinetoram+Fungicide; or Spinetoram+FungicideA+FungicideB; or Spinetoram+Plant Health Additive; or Spinetoram+Insecticide+Plant Health Additive; or Spinetoram+Fungicide+Plant Health Additive; or Spinetoram+Insecticide+Fungicide.

Further aspect of the present invention to provide novel agrochemical Oil Dispersion (OD) formulation comprising at least one active ingredient suspended in oil phase shows synergistic activity and stability over wide range of the conditions.

Further aspect of the present synergistic Oil Dispersion (OD) composition is to provide selection of suitable formulation excipients selected from category of super wetting-spreading-penetrating agent, carrier or solvent, emulsifying agent, dispersing agent, stabilizers, buffering agent, antifoaming agent, preservative, anti-freezing agent and buffering agents.

Another aspect of the present invention to provide synergistic agrochemical Oil Dispersion (OD) formulation comprising Super Wetting-spreading-penetrating agent—Polyalkyleneoxide modified Heptamethyl trisiloxane (Modified trisiloxane).

Further aspect of the present invention to provide synergistic agrochemical Oil Dispersion (OD) formulation comprising carrier or solvent selected from Pongamia/karanja/karanj oil; or palm oil; or pongamia oil and palm oil; or pongamia oil and jojoba oil; or palm oil and jojoba oil; or pongamia oil and vegetable oil; or palm oil and vegetable oil; or pongamia oil and palm oil and vegetable oil; or solvent; or both.

In a further embodiment of the present invention, an insecticide may be selected from Carbamates; Organophosphates; Phenylpyrazole; Pyrethroids; Nicotinic insecticides; Mectins; Juvenile hormone mimics; Chordotonal organs modulators; Mite growth inhibitors; Microbial disruptors of insect midgut membrane; Inhibitors of mitochondrial ATP synthase; Uncouplers of oxidative phosphorylation; Nereis toxin; Chitin biosynthesis inhibitors; Inhibitors of the chitin biosynthesis type 1; Moulting disruptors; Ecdyson receptor agonists; Octopamin receptor agonists; METI (mitochondrial electron transport inhibitors; Voltage-dependent sodium channel blockers; Inhibitors of the lipid synthesis, inhibitors of acetyl COA carboxylase; Diamides; Metadiamides; Isoxazolines; Baculoviruses; compounds of unknown or uncertain mode of action.

In a further embodiment of the present invention, a fungicide may be selected from Nucleic acid synthesis inhibitors; Cytoskeleton and motor proteins/cell division Inhibitors; Respiration inhibitors; Amino acids and protein synthesis inhibitors; Signal transduction inhibitors; Lipid or transport and membrane synthesis inhibitors; Sterol biosynthesis Inhibitors; Cell wall biosynthesis Inhibitors; Melanin synthesis in cell wall Inhibitors; Plant defence inducers; Unknown mode of action; Not classified (N); Chemicals with multisite activities (M)-multisite contact activities; Biologicals with multiple modes of action (BM); others.

In a further embodiment of the present invention, plant health additives are selected from bio-stimulants, plant growth regulators, microbial agents and micronutrients or mixture thereof.

The present synergistic agrochemical Oil Dispersion (OD) composition comprising bioactive amount of (A) Spinetoram; and (B) at least one more of active ingredients selected from class of insecticides or fungicides or plant health additive or combination thereof described herein is obtained by a process comprising a step of preparing the liquid premix by charging the oil or solvent or both followed by adding super wetting-spreading-penetrating agent. The further step is adding the active ingredients into the premixed through milling for the proper size distribution. Further adding the thickening agent followed by stirring the slurry get prepared by milling process to prepare the final formulation. These agrochemical oil dispersion formulations can be used in spray mixtures in agriculture.

### DETAIL DESCRIPTION OF THE INVENTION

Formulation technology in the field of an agriculture is now seen as an “enabling technology” which can provide safe and effective products which are convenient to use. It can also modify the toxicity of active ingredients and improve their ability to target a specific pest. At a time when the discovery of new agrochemical compounds is more difficult and certainly a high risk and expensive operation, formulation technology can extent the useful patent life of an active ingredient. It can also provide a competitive edge by improving product quality of existing formulations, or by introducing a new formulation of an active ingredient.

OD formulations are non-aqueous dispersion intended for dilution into water before use, and represent the most complex of the non-aqueous suspension formulations. Oil dispersion (OD) formulations consist of a suspension of a solid technical in oil. The oil also serve as a carrier or solvent for additives. The oil dispersion is usually dispersed in water prior to spraying.

An Oil Dispersion is a non-aqueous suspension concentrate. It combines a very good biological efficacy with an environmental friendly formulation. The active ingredient is dispersed in oils or methylated crop oils.

Oil Dispersion formulation comprises with some features as it comprises no aromatic solvent or reduced amount of aromatic solvent; is non-aqueous formulation; non-flammable and low volatility; higher efficiency.

Oil Dispersion (OD) have several advantages over standard formulations. Emulsifiable Concentrates (ECs) formulations are under a strong regulatory pressure to replace toxic and flammable solvents with a less toxic and non-flammable solutions. The novel ODs meets these needs: the oil content gives a favourable eco-toxicological profile guarantying a very high biological efficacy. Further the novel OD formulations are non-toxic and non-flammable formulations. Over the EC formulation the novel OD formulation is having very high biological efficacy.

Suspension concentrates (SC) formulations are very safe formulations but the aqueous media is normally not ideal to boost the pesticide's biological efficacy. As an agriculture growers standard practice, tank mix adjuvants are added to guarantee a higher performance. The novel OD, with its oil content, guarantees the best biological results. For water sensitive active ingredients, the novel OD represents the sole technical solution to liquid formulation. The novel OD formulation over SC formulation is very safe formulation along with high biological performance. Further the novel OD formulation is ideal for all the active ingredients not stable in water.

Water dispersible granules (WDG) formulations are very safe but quite expensive. Optimal biological efficacy requires adjuvants. The novel OD, with its oil content and better particle size distribution, combines high efficacy with better cost. The novel OD formulation over WDG has economic significance as having better efficacy at a lower cost.

OD formulation presents several challenges in preparation and manufacturing phase. To obtain a good and stable formulation over time, optimal formulation additives are required in addition to optimum processes. Particular attention must be given to choice of all the formulation excipients. Its dispersion and activation are key to the stability of the formulation over time.

Some important requirement of the formulation excipients are perfectly dispersible in oil, no phase separation, easy milling, with no agglomeration, excellent oil emulsification, stable dilution, good coverage and penetration, even distribution through the whole formulation, provide the right yield value of active ingredients.

Therefore an aspect of the present invention provides a synergistic agrochemical Oil Dispersion (OD) composition comprising bioactive amount of (A) Spinetoram; and (B) at least one more of active ingredients selected from class of insecticides or fungicides or plant health additive or combination thereof.

Further aspect of the present invention to provide novel agrochemical Oil Dispersion (OD) formulation comprising at least one active ingredient suspended in oil phase shows synergistic activity and stability over wide range of the conditions.

In an especially preferred embodiment of the invention, the yield of the treated plant is increased.

In another preferred embodiment of the invention, the yield of the plants treated according to the method of the invention, is increased synergistically.

The term “synergistic”, as used herein, refers the combined action of two or more active agents blended together and administered conjointly that is greater than the sum of their individual effects.

Another aspect of the present invention is to provide the a synergistic agrochemical Oil Dispersion (OD) composition comprising possible combinations of Spinetoram+Insecticide; or Spinetoram+Insecticide A+Insecticide B; or Spinetoram+Fungicide; or Spinetoram+FungicideA+FungicideB; or Spinetoram+Plant Health Additive; or Spinetoram+Insecticide+Plant Health Additive; or Spinetoram+Fungicide+Plant Health Additive; or Spinetoram+Insecticide+Fungicide.

Further aspect of the present invention to provide synergistic agrochemical Oil Dispersion (OD) formulation comprising formulation excipients from the category of emulsifying agent, dispersing agent, stabilizers, buffering agent, antifoaming agent, preservative, anti-freezing agent and buffering agents.

In an embodiment of the present synergistic agrochemical Oil Dispersion (OD) formulation, at least one more of active ingredient component (B) is selected from compound from group of insecticide, or fungicide, or plant health additives or combination thereof.

In an embodiment of the present invention, an insecticide may be selected from Carbamates; Organophosphates; Phenylpyrazole; Pyrethroids; Nicotinic insecticides; Mectins; Juvenile hormone mimics; Chordotonal organs modulators; Mite growth inhibitors; Microbial disruptors of insect midgut membrane; Inhibitors of mitochondrial ATP synthase; Uncouplers of oxidative phosphorylation; Nereis toxin; Chitin biosynthesis inhibitors; Inhibitors of the chitin biosynthesis type 1; Moulting disruptors; Ecdyson receptor agonists; Octopamin receptor agonists; METI (mitochondrial electron transport inhibitors; Voltage-dependent sodium channel blockers; Inhibitors of the lipid synthesis, inhibitors of acetyl CoA carboxylase; Diamides; Metadiamides; Isoxazolines; Baculoviruses; compounds of unknown or uncertain mode of action.

In a further embodiment of the present invention, an insecticide may be selected from: Carbamates: —carbaryl, carbofuran, carbosulfan, methomyl, oxamyl, pirimicarb, thiodicarb; Organophosphates: —acephate, cadusafos, chlorpyrifos, chlorpyrifos-methyl, demeton-S-methyl, dimethoate, ethion, fenamiphos, fenitrothion, fenthion, fosthiazate, methamidophos, monocrotophos, oxydemeton-methyl, parathion, parathion-methyl, phenthoate, phorate, phosalone, phosphamidon, profenofos, quinalphos, triazophos; Phenylpyrazole: —ethiprole, fipronil, flufiprole, nicofluprole, pyrafluprole, or pyriprole; Pyrethroids: —bifenthrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, fenpropathrin, fenvalerate, tau-fluvalinate, permethrin, phenothrin, prallethrin, profluthrin, pyrethrin (pyrethrum); Nicotinic insecticides: —acetamiprid, clothianidin, dinotefuran, imidacloprid, nitenpyram, thiacloprid, thiamethoxam, flupyrimin, cycloxaprid, paichongding, guadipyr, cycloxylidin, sulfoxaflor, flupyradifurone, triflumezopyrim, dichloromezotiaz;

Mectins: —abamectin, emamectin benzoate, ivermectin, lepimectin, milbemectin; Juvenile hormone mimics: —hydroprene, kinoprene, methoprene, fenoxycarb, pyriproxyfen; Chordotonal organs modulators-pymetrozine, pyrifluquinazon, afidopyropen, flonicamid; Mite growth inhibitors: —clofentezine, hexythiazox, diflovidazin or etoxazole; Microbial disruptors of insect midgut membrane: —Bacillus thuringiensis and insecticidal proteins; Inhibitors of mitochondrial ATP synthase: —diafenthiuron, azocyclotin, cyhexatin, fenbutatin oxide, propargite, or tetradifon;

Uncouplers of oxidative phosphorylation: —chlorfenapyr, DNOC, or sulfluramid; Nereis toxin: —bensultap, monosultap, cartap hydrochloride, thiocyclam, thiocyclam hydrogen oxalate, thiocyclam hydrochloride, thiosultap sodium; Chitin biosynthesis inhibitors: —benzoylureas-bistrifluron, chlorfluazuron, diflubenzuron, flucycloxuron, flufenoxuron, hexaflumuron, lufenuron, novaluron, noviflumuron, teflubenzuron, triflumuron; Inhibitors of the chitin biosynthesis type 1: —buprofezin; Moulting disruptors: —cyromazine; Ecdyson receptor agonists: —diarylhydrazines—methoxyfenozide, tebufenozide, halofenozide, fufenozide or chromafenozide; Octopamin receptor agonists: —amitraz; METI (mitochondrial electron transport inhibitors: —fenazaquin, fenpyroximate, pyrimidifen, pyridaben, tebufenpyrad, tolfenpyrad, flufenerim, rotenone, cyenopyrafen, cyflumetofen, pyflubumidemm, hydramethylnon, acequinocyl, flometoquin, fluacrypyrim, pyriminostrobin or bifenazate; Voltage-dependent sodium channel blockers: —oxadiazines-indoxacarb, semicarbazones-metaflumizone; Inhibitors of the lipid synthesis, inhibitors of acetyl COA carboxylase: —Tetronic and tetramic acid derivatives-spirodiclofen, spiromesifen, spirotetramat, spidoxamat or spiropidion; Diamides: —chlorantraniliprole, cyantraniliprole, cyclaniliprole, cyhalodiamide, cyproflanilide, flubendiamide, tetraniliprole, tetrachlorantraniliprole, tyclopyrazoflor; Metadiamides-broflanilide; Isoxazolines-fluxametamide, isocycloseram; Baculoviruses: —granuloviruses and nucleopolyhedrosis viruses; Compounds of unknown or uncertain mode of action: —azadirechtin, benzpyrimoxan (insect growth regulators), pyridalyl, oxazosulfyl, dimpropyridaz (carboxamide insecticide), flometoquin, fluhexafon, cyetpyrafen, flupentiofenox, acyonapyr, cyclobutrifluram, fluazaindolizine, tioxazafen.

In a further embodiment of the present invention, a fungicide may be selected from Nucleic acid synthesis inhibitors; Cytoskeleton and motor proteins/cell division Inhibitors; Respiration inhibitors; Amino acids and protein synthesis inhibitors; Signal transduction inhibitors; Lipid or transport and membrane synthesis inhibitors; Sterol biosynthesis Inhibitors; Cell wall biosynthesis Inhibitors; Melanin synthesis in cell wall Inhibitors; Plant defence inducers; Unknown mode of action; Not classified (N); Chemicals with multisite activities (M)-multisite contact activities; Biologicals with multiple modes of action (BM); others.

In an embodiment of the present invention, a fungicide may be selected from Nucleic acid synthesis inhibitors; Cytoskeleton and motor proteins/cell division Inhibitors; Respiration inhibitors; Amino acids and protein synthesis inhibitors; Signal transduction inhibitors; Lipid or transport and membrane synthesis inhibitors; Sterol biosynthesis Inhibitors; Cell wall biosynthesis Inhibitors; Melanin synthesis in cell wall Inhibitors; Plant defence inducers; Unknown mode of action; Not classified (N); Chemicals with multisite activities (M)-multisite contact activities;

In a further embodiment of the present invention, a fungicide may be selected from:

### a) Nucleic Acid Synthesis Inhibitors: —

PhenylAmides group (A1)-Acylalanines-benalaxyl, benalaxyl-M (=kiralaxyl), furalaxyl, metalasxyl, metalaxyl-M (=mefenoxam)), butyrolactones (ofurace), oxazolidinones (oxadixyl), hydroxy-(2-amino-)pyrimidines; A2. bupirimate, dimethirimol, ethirimol, heteroaromatics; (A3)-isothiazolones-octhilinone, isoxazoles-hymexazole; carboxylic acids(A4)-oxolinic acid; Other-5-fluorocytosine, 5-fluoro-2-(p-tolylmethoxy)pyrimidin-4-amine, 5-fluoro-2-(4-fluorophenylmethoxy)pyrimidin-4-amine;

### b) Cytoskeleton and Motor Proteins/Cell Division Inhibitors: —

benzimidazoles(B1)-benomyl, carbendazim, fuberidazole, thiabendazole; thiophanates(B1)-thiophanate, thiophanate-methyl; N-phenyl carbamates(B2)-diethofencarb; toluamides(B3)-zoxamide; ethylamino-thiazole-carboxamide (B3)-ethaboxam; phenylureas (B4)-pencycuron; pyridinylmethyl benzamides (B5)-fluopicolide, flufenoxadiazam, fluopimomide; aminocyanoacrylates (B6)-phenamacril; benzophenone(B6)-metrafenone; benzoylpyridine(B6)-pyriofenone.

### c) Respiration Inhibitors: —

Pyrimidinamines(C1)-diflumetorim; pyrazole-5-carboxamide(C1)-tolfenpyrad; quinazoline(C1)-fenazaquin; SDHI (Succinate dehydrogenase inhibitors) (C2)-phenyl-benzamides(C2)-benodanil, flutolanil, mepronil; phenyl-oxo-ethyl thiophene amid(C2)-isofetamid; pyridinyl-ethyl-benzamides(C2)-fluopyram; furan-carboxamides(C2)-fenfuran; oxathin-carboxamides(C2)-carboxin, oxycarboxin, thiazole-carboxamides(C2)-thifluzamide; pyrazole-4-carboxamides(C2)-benzovindiflupyr, bixafen, fluindapyr, fluxapyroxad, furametpyr, isopyrazam, penflufen, penthiopyrad, sedaxane, flubeneteram, pyrapropoyne, inpyrfluxam, isoflucypram, pydiflumetofen; pyridine carboxamides(C2)-boscalid, pyraziflumid; QoI-fungicides (Quinone outside Inhibitors) (C3)-benzyl carbamates-pyribencarb; dihydro dioxazines-fluoxastrobin; imidazolinones-fenamidone; methoxy acetamide; mandestrobin; methoxy acrylates-azoxystrobin, coumoxystrobin, enoxastrobin, flufenoxystrobin, picoxystrobin, pyraoxystrobin; methoxy carbamates-pyraclostrobin, pyrametostrobin, triclopyricarb; oxazolidine diones-famoxadone; oximino acetamides-dimoxystrobin, fenamistrobin, metominostrobin, orysastrobin; oximino acetates-kresoxim methyl, trifloxystrobin; QiI-fungicides (Quinone inside Inhibitors) (C4)-cyano imidazole-cyazofamid; sulfamoyl triazole-amisulbrom; picolinamides-fenpicoxamid, florylpicoxamid, metarylpicoxamid; tetrazolinones-metyltetraprole; uncouplers of oxidative phosphorylation (C5)-dinitophenyl crotonates (C5)-binapacryl, meptyldinocap, dinocap, 2,6-dinitro anilines (C5)-fluazinam, inhibitors of oxidative phosphorylation, ATP synthase (C6)-tri phenyl tin compounds (C6)-fentin acetate, fentin chloride, fentin hydroxide, ATP transport(C7)-thiophene (C7)-silthiofam, Quinone outside Inhibitors, stigmatellin binding type (QoSI-C8) triazolo pyrimidylamine (C8)-ametoctradin;

d) Amino acids and protein synthesis inhibitors—anilino-pyrimidines (D1)-cyprodinil, mepanipyrim, pyrimethanil, enopyranuronic acid antibiotic (D2)-blasticidin-S, hexopyranosyl antibiotic (D3)-kasugamycin, glucopyranosyl antibiotic (D4)-streptomycin, tetracycline antibiotic (D5)-oxytetracycline;
e) Signal transduction inhibitors: —aryloxyquinoline (E1)-quinoxyfen, quinazolinone (E1)-proquinazid, phenylpyrroles (E2)-fenpiclonil, fludioxonil, dicarboximides (E3)-chlozolinate, dimethachlone, iprodione, procymidone, vinclozolin;
f) Lipid or transport and membrane synthesis inhibitors: —dithiolanes (F2)-isoprothiolane, phosphorthiolates(F2)-edifenphos, iprobenfos (IBP), pyrazophos, aromatic hydrocarbons (F3)-biphenyl, chloroneb, dicloran, quintozene, tecnazene, tolcofos methyl, etridiazole, carbamates (F4)-iodocarb, propamocarb, prothiocarb, terpene hydrocarbons (F7)-extract from Melaleuca alternifolia (tea tree), plant oils (mixtures); eugenol, geraniol, thymol, amphoteric macrolide antifungal (F8)-natamycin (pimaricin), piperidinyl thiazole isoxazolines (F9)-oxathiapipronil, fluoxapipronil, Fluoxapiprolin-s;
g) Sterol biosynthesis Inhibitors: —imidazoles(G1)-imazalil, imidazoles(G1)-oxpoconazole, pefurazoate, procloraz, triflumizole, piperazines-triforine, pyridines-pyrifenox, pyrisoxazole, pyrimidines-fenarimo, naurimol, triazoles-azaconazole, bitertanol, bromuconazole, cyproconazole, difenoconazole, diniconazole, epoxiconazole, etaconazole, fenbuconazole, fluquinconazole, flusilazole, frutriafol, hexaconazole, imibenconazole, ipconazole, mefentrifluconazole, metconazole, myclobutanil, penconazole, propiconazole, prothioconazole, simconazole, tebuconazole, tetraconazole, tiradimefon, tiradimenol, triticonazole, fluoxytioconazole, morpholines (G2)-aldimoprh, dedomorph, tridemorph, fenpropimorph, piperidines (G2)-fenpropidin, piperalin, spiroketal amines (G2)-spiroxamine, amino pyrazolinone (G3)-fenpyrazamine, hydroxyanilides (G3)-fenhexamid, allaylamines (G4)-naftifine, terbinafine, pyributicarb;
h) Cell wall biosynthesis Inhibitors: —peptidpyl pyrimidine (H4)-polyoxin, cinnamic acid amides (H5)-dimethomorph, flumorph, pyrimorph, mandelic acid amides (H5)-mandipropamid, valinamide carbamates (H5)-benthiavalicard, iprovalicarb, alifenalate;
i) Melanin synthesis in cell wall Inhibitors: —isobenzo furanone (I1)-phthalide, pyrrolo quinolinone-pyroquilon, triazolobenzothiazole-tricyclazole, carboxamide (I2)—diclycymet, cyclopropane carboxamide (I2)-carpropamid, propionamide(I2)-fenoxanil, trifluoroethyl carbamate (I3)-tolprocarb,
p) Plant defence inducers: —benzothiadiazole (P1)-acibenzolar-S-methyl, probenazole, thiadiazole (P3)-tiadinil, isotianil, polysaccharides (P4)-laminarin, complex mixture thanol extract (P5)-extract from Reynoutria sachalinensis (giant knowweed), bacterial Bacillus (P6)-Bacillus mycoides isolate J, cell awall of Saccharomyces cerevisiae strain LAS117, phosphonates(P7)-fosetyl-AL, phosphoric acid and salts,
u) Unknown mode of action: —cyanoacetamide oxime-cymoxanil, phthalamic acid-tecloftalam, benzotirazines-triazoxide, benzene-sulfonamides-flusulfamide, pyridazinones-diclomezine, phenyl acetamide-cyflufenamid, guanidines-dodine, cyano methylene thiazolidines-flutianil, pyrimidinone hydrazones-ferimzone, flumetylsulforim, 4-quinolyl acetates-tebufloquin, tetrazolyloximes-picarbutrazox, glucopyranosyl antibiotics-validamycin,
n) Not classified (N)—mineral oils, inorganic oils, organic oils, potassium bicarbonates, materials of biological origin,
m) Chemicals with multisite activities (M)-multisite contact activities—inorganic-copper (copper hydroxide, copper oxychloride, copper (II) sulphate, Bordeaux mixture, copper salicylate, cuprous oxide), sulphur, dithiocarbamates and relatives-ferbam, mancozeb, maneb, metiram, propineb, thiram, zinc thiazole, zineb, ziram, phthalimides-captan, captafol, folpet, chloronitriles (phthalonitriles)-chlorothalonil, sulfamides-dichlofluanide, tolylfluanide, bis guanidines-guazatine, iminoctadine, triazines-anilazine, quinones (anthraquinones)-dithianon, quinoxalines-chinomethionat/quinomethionate, maleimide-fluoroimide, thiocarbamate-methasulfocarb,
(n) Biologicals with multiple modes of action (BM)—polypeptide (lectin)-extract from the cotyledons of lupine plantlets (“BLAD”), Plant extract-Phenols, Sesquiterpenes, Triterpenoids, Coumarins, microbial (living microbes or extract metabilites-Trichoderma atroviride strain SC1, Trichoderma atroviride strain I-1237, Trichoderma atroviride strain LU132, Trichoderma asperellum strain T34, Gliocladium catenulatum strain J1446, Clonostachys rosea strain CR-7, Bacillus amyloliquefaciens strain QST713, strain FZB24, strain MBI600, strain D747, strain F727, Bacillus subtilis strain AFS032321, Pseudomonas chlororaphis strain AFS009, Streptomyces griseovirides strain K61, Streptomyces lydicus strain WYEC108

Others: —Ipflufenoquin-quinoline fungicide, Pyridachlometyl-pyridazine fungicide, quinofumelin, dichlobentiazox, aminopyrifen, dipymetitrone, seboctylamine (bactericide), chloroinconazide (virucide).

### Plant Health Additives:

Plant health additives are products that reduce the need for fertilizers and increase plant growth, resistance to water and abiotic stresses. In small concentrations, these substances are efficient, favouring the good performance of the plant's vital processes, and allowing high yields and good quality products. In addition, plant health additives applied to plants enhance nutrition efficiency, abiotic stress tolerance and/or plant quality traits, regardless of its nutrient contents. Several researches have been developed in order to evaluate the plant health additives in improving plant development subjected to stresses, saline environment, and development of seedlings, among others. Furthermore, various raw materials have been used in plant health additives compositions, such as humic acids, hormones, algae extracts, and plant growth-promoting bacteria. In this sense, this chapter aims to approach the use of plant health additives in plant growth according to the raw material used in their compositions as well as their effects on plants subjected to abiotic stresses.

In a further embodiment of the present invention, plant health additives are selected from bio-stimulants, plant growth regulators, microbial agents and micronutrients or mixture thereof.

In further embodiment of the present invention, plant health additives are selected from Bio stimulants are humic acid (salts), fulvic acid (salts), amino acids (alanine, arginine, aspartic acid, cysteine, glutamic acid, glycine, histidine, isoleucine, leucine, lysine, methionine, phenylalanine, proline, serine, threonine, tryptophan, tyrosine, valine or mixture thereof), protein hydrolysates, peptides, organic acid, acetyl thioproline, thiazolidine carboxylic acid, jasmonic acid, methyl jasmonate, chitosan, chitin, Probenazole, acibenzolar-s-methyl, seaweed extract (Ascophyllum nodosum), polyamines, silicic acid (salts)-orthosilicic acid (H4Si04), salicylic acid, lactic acid, phenyl lactic acid, fumaric acid, acibenzolar-s-methyl, nitrobenzene, (Homo)brassinolide, forchlorfenuron, triacontanol, nitrophenolate (sodium para-nitrophenolate, ortho-nitrophenolate, sodium-5-nitroguaiacolate or mixture thereof;

Plant growth regulators are Auxins: Indole acetic acid, Indole butyric acid, alpha-naphthyl acetic acid; Cytokinins: kinetin, zeatin, 6-benzylaminopurine, 6-benzyladenine, dipheylurea, thidiazuron, anisiflupurin; Ethylene modulators: aviglycine, prohexadione, prohexadione calcium, trinexapac, trinexapac-ethyl, aminoethoxyvinylglycine (AVG); Gibberellins: gibberelline, gibberellic acid, GA3; Growth inhibitors: abscisic acid, chlorpropham, flumetralin, maleic hydrazide, mepiquat, mepiquat chloride, mepiquat pentaborate; Growth retardants: chlormequat, chlormequat chloride, paclobutrazol, uniconazole-P; or mixture thereof;

Microbial agents are Rhizobium spp., Azotobacter spp., Azospirillum spp., Acetobacter spp., Bacillus megaterium var. phosphaticum, Bacillus polymyxa, Bacillus licheniformis, Frateuria aurantia, Thiobacillus thiooxidans, VAM (Vesicular Arbuscular Mycorrhiza) (Acaulospora spp., Gigaspora spp., Sclerocystis spp., Scutellospora spp., Glomus spp. Etc.), Acinetobacter calcoaceticus, Bacillus subtilis, Bacillus thuringiensis var. kurstaki, Pseudomonas fluorescens, Beauveria bassiana, Metarhizium anisopliae, Verticillium lecanii, Trichoderma viride, Trichoderma harzianum, Paecilomyces lilacinus, Trichoderma spp. etc. or mixture thereof;

Micronutrients are zinc (zinc sulphate heptahydrate, zinc sulphate mono hydrate, Zn-EDTA, zinc oxide, zinc lactate gluconate, zinc polyflavonoid), ferrous sulphate, copper sulphate, Manganese sulphate, boron (borax-sodium tetraborate, boric acid (H₃BO₃), di-sodium octa borate tetra hydrate (Na2B8O13·4H2O), di-sodium tetra borate penta hydrate, anhydrous borax) and sulphur (elemental sulphur, bentonite sulphur, boronated sulphur or a sulphate and thiosulphate salt) or mixture thereof.

The present inventors believe that the combination of the present invention synergistic agrochemical Oil Dispersion (OD) composition comprising bioactive amount of (A) Spinetoram; and (B) at least one more of active ingredients selected from class of insecticides or fungicides or plant health additive or combination thereof surprisingly results in a synergistic action. The combination of the present invention allows for a broad spectrum of insect-pest and diseases control and has surprisingly improved plant vigour and yield. The broad spectrum of the present combination also provides a solution for preventing the development of resistance.

The synergistic agrochemical mixture has very advantageous curative, preventive and systemic pesticidal properties for protecting cultivated plants. As has been mentioned, said active ingredient composition can be used to inhibit or destroy the insect-pests and fungal and bacterial diseases that occur on plants or parts of plants of useful crops. The synergistic agrochemical composition of specific active ingredient has the special advantage of being highly active against insect pests and fungal and bacterial diseases that mostly occur on plant parts.

The synergistic agrochemical composition of the present invention is used to protect the crops and plants from insect pest and fungal and bacterial diseases. Examples of the crops on which the present compositions may be used include but are not limited to GMO (Genetically Modified Organism) and Non GMO varieties of Cotton (Gossypium spp.), Paddy (Oryza sativa), Wheat (Triticum aestivum), Barley (Hordeum vulgare), Maize (Zea mays), Sorghum (Sorghum bicolor), Oat (Avena sativa), Pearl millet (Pennisetum glaucum), Sugarcane (Saccharum officinarum), Sugarbeet (Beta vulgaris), Soybean (Glycin max), Peanut (Arachis hypogaea), Sunflower (Helianthus annuus), Mustard (Brassica juncea), Rape seed (Brassica napus), Linseed (Linum usitatissimum), Sesame (Sesamum indicum), Green gram (Vigna radiata), Black gram (Vigna mungo), Chickpea (Cicer aritinum), Cowpea (Vigna unguiculata), Redgram (Cajanus cajan), Frenchbean (Phaseolus vulgaris), Indian bean (Lablab purpureus), Horse gram (Macrotyloma uniflorum), Field pea (Pisum sativum), Cluster bean (Cyamopsis tetragonoloba), Lentils (Lens culinaris), Brinjal (Solanum melongena), Cabbage (Brassica oleracea var. capitata), Cauliflower (Brassica oleracea var. botrytis), Okra (Abelmoschus esculentus), Onion (Allium cepa L.), Tomato (Solanum lycopersicum), Potato (Solanum tuberosum), Sweet potato (Ipomoea batatas), Chilly (Capsicum annum), Garlic (Allium sativum), Cucumber (Cucumis sativus), Muskmelons (Cucumis melo), Watermelon (Citrullus lanatus), Bottle gourd (Lagenaria siceraria), Bitter gourd (Momordica charantia), Radish (Raphanus sativus), Carrot (Dacus carota subsp. sativus), Turnip (Brassica rapa subsp rapa), Apple (Malus domestica), Banana (Musa spp.), Citrus groups (Citrus spp.), Grape (Vitis vinifera), Guava (Psidium guajava), Litchi (Litchi chinensis), Mango (Mangifera indica), Papaya (Carica papaya), Pineapple (Ananas comosus), Pomegranate (Punica granatum), Sapota (Manilkara zapota), Tea (Camellia sinensis), Coffea (Coffea Arabica), Turmeric (Curcuma longa), Ginger (Zingiber officinale), Cumin (Cuminum cyminum), Fenugreek (Trigonella foenum-graecum), Fennel (Foeniculum vulgare), Coriander (Coriandrum sativum), Ajwain (Trachyspermum ammi), Psyllium (Plantago ovate), Black Pepper (Piper nigrum), Stevia (Stevia rebaudiana), Safed musli (Chlorophytum tuberosum), Drum stick (Moringa oleifera), Coconut (Coco nucifera), Mentha (Mentha spp.), Rose (Rosa spp.), Jasmine (Jasminum spp.), Marigold (Tagetes spp.), Common daisy (Bellis perennis), Dahlia (Dahlia hortnesis), Gerbera (Gerbera jamesonii), Carnation (Dianthus caryophyllus), vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

The synergistic agrochemical Oil Dispersion (OD) composition comprising bioactive amount of (A) Spinetoram; and (B) at least one more of active ingredients selected from class of insecticides or fungicides or plant health additive or combination is most suitable against wide range of insect-pests. The major insects pests controlled with Novel OD (Oil Dispersion) formulations are belongs to the order Hemiptera, for example, rice leafhopper/green leaf hopper (GLH) Nephotettix nigropictus, rice brown plant hopper (BPH) Nilaparvata lugen, rice backed plant hopper (WBPH) Sogatella furcifera, Apple Mealy bug Phenococcus aceris, bean aphid Aphis fabae, black citrus aphid Toxoptera aurantii, citrus black scale Saissetia oleae, cabbage aphid Brevicoryne brassicae, Lipaphis erysimi, citrus red scale Aonidiella aurantii, yellow scale Aonidiella citrine, citrus mealybug Planococcus citri, corn leaf aphid Rhopalosiphum maidis, aphid Aphis gossypii, jassid Amrasca biguttula biguttla, mealy bug Planococcus spp. And Pseudococcus spp., cotton stainer Dysdercus suturellus, whitefly Bemisia tabaci, cowpea aphid Aphis craccivora, grain aphid Sitobion avenae, golden glow aphid Uroleucon spp., grape mealybug Pseudococcus maritimus, green peach aphid Myzus persicae, greenhouse whitefly Trialeurodes vaporariorum, papaya mealy bug Paracoccus marginatus, pea aphid Acyrthosiphon pisum, sugarcane mealybug Saccharicoccus sacchari, potato aphid Myzus persicae, potato leaf hopper Empoasca fabae, cotton whitefly Bemisia tabaci, tarnished plant bug Lygus lineolaris, wooly apple aphid Eriosoma lanigerum, mango hopper Amritodus atkinsoni, Idioscopus spp.; order Lepidoptera, army worm Mythimna unipuncta, asiatic rice borer Chilo suppressalis, bean pod borer Maruca vitrata, beet armyworm Spodoptera exigua, black cutworm Agrotis ipsilon, bollworm Helicoverpa armigera, cabbage looper Trichoplusia ni, codling moth Cydia pomonella, croton caterpillar Achea janata, diamond backmoth Plutella xylostella, cabbage worm Pieris rapae, pink bollworm Pectinophora gossypiella, sugarcane borer Diatraea saccharalis, sugarcane early shoot borer Chilo infuscatellus tobacco budworm Heliothis virescens, tomato fruitworm Helicoverpa zea, velvet bean caterpillar Anticarsia gemmatalis, yellow stem borer Scirpophaga incertulas, spotted bollworm Earias vittella, rice leaffolder Cnaphalocrocis medinalis, pink stem borer Sesamia spp., tobacco leafeating caterpillar Spodoptera litura; brinjal fruit and shoot borer Leucinodes orbonalis, bean pod borer Maruca vitrata, Maruca testulalis, armyworm Mythimna separata, cotton pinkbollworm Pectinophora gossypiella, citrus leafminer Phyllocnistis citrella, cabbage butterfly Pieris bras-sicae, diamond backmoth Plutella xylostella, paddy stem borer Scirpophaga excerptallis, Scirpophaga incertulas, Scirpophaga innotata, wheat stem borer Sesamia inferens, Sitotroga cerealella, Spilosoma obliqua, fall armyworm Spodoptera frugiperda, Spodoptera littoralis, Spodoptera litura, Trichoplusia ni, Tryporyza nivella, Tryporyza incertulas, Tuta absoluta.

from the order Coleoptera, for example, apple twig borer Amphicerus spp., corn root worm Diabrotica virgifera, cucumber beetle Diabrotica balteata, boll weevil Anthonomus grandis, grape flea beetle Altica chalybea, grape root worm Fidia viticola, grape trunk borer Clytoleptus albofasciatus, radish flea beetle Phyllotreta armoraciae, maize weevil Sitophilus zeamais, northern corn rootworm Diabrotica barberi, rice water weevil Lissorhoptrus oryzophilus, Anthonomus grandis, Bruchus lentis, Diabrotica semipunctata, Diabrotica virgifera, Dicladispa armigera, Epila-chna varivestis, various species of white grubs are Holotrichia bicolor, Holotrichia consanguinea, Holotrichia serrata, Leptinotarsa decemlineata, Phyllotreta chrysocephala, Popillia japonica etc; from the order Orthoptera, for example, Gryllotalpa spp., Locusta spp., and Schistocerca is spp.; from the order Thysanoptera, for example, Thrips-Frankliniella spp., Thrips palmi, Thrips tabaci and Scirtothrips dorsalis; termites (Isoptera), e.g. Calotermes flavicollis, Coptotermes formosanus, Heterotermes aureus, Leucotermes flavipes, Microtermes obesi, Odontotermes obesus, Reticulitermes flavipes, Termes natalensis; from the order Heteroptera, for example, Dysdercus spp., Leptocorisa spp., from the order Hymenoptera, for example, Solenopsis spp.; from the order Diptera, for example, Antherigona soccata, Dacus spp., Liriomyza spp., Melanagromyza spp., from the order Acarina, for example, Aceria mangiferae, Brevipalpus spp., Eriophyes spp., Oligonychus mangiferus, Oligonychus punicae, Panonychus citri, Panonychus ulmi, Polyphagotarsonemus latus, Tarsonemus spp., Tetranychus urticae, Tetranychus cinnabarinus.

The novel OD formulations have very good fungicidal bactericidal properties and can be employed for controlling phytopathogenic fungi such as Ascomycetes, Basidiomycetes, Chytridiomycetes, Deuteromycetes, Oomycetes, Plasmodiophoromycetes, Zygomycetes, and the like.

Examples which may be mentioned, but not by limitation, are some pathogens of fungal diseases

### Which Come Under the Above Generic Terms:

Diseases caused by pathogens causing powdery mildew such as, for example, Blumeria species such as, for example, Blumeria graminis; Podosphaera species such as, for example, Podosphaera leucotricha; Oidium species such as, for example Oidium mangiferae, Sphaerotheca species such as, for example, Sphaerotheca fuliginea; Uncinula species such as, for example, Uncinula necator; Leveillula species such as, for example Leveillula taurica, Erysiphe species such as for example Erysiphe polygoni, diseases caused by pathogens of rust diseases such as, for example, Gymnosporangium species such as, for example, Gymnosporangium sabinae, Hemileia species such as, for example, Hemileia vastatrix; Phakopsora species such as, for example, Phakopsora pachyrhizi and Phakopsora meibomiae; Puccinia species such as, for example, Puccinia graminis, Puccinia recondita or Puccinia triticina, Puccinia striiformis; Uromyces species such as, for example, Uromyces phaseoli; diseases caused by pathogens of smut diseases such as, for example, Sporisorium species such as, for example, Sporisorium scitamineum; Ustilago species such as, for example Ustilago maydis, Tilletia species such as for example Tilletia tritici, Ustilaginoidea species such as, for example Ustilaginoidea virens, diseases caused by pathogens of ergot diseases such as, for example Claviceps species, Claviceps purpurea; diseases caused by pathogens from the group of the Oomycetes such as, for example, Bremia species such as, for example, Bremia lactucae; Peronospora species such as, for example, Peronospora pisi or P. brassicae; Phytophthora species such as, for example, Phytophthora infestans; Plasmopara species such as, for example, Plasmopara viticola; Pseudoperonospora species such as, for example, Pseudoperonospora humuli or Pseudoperonospora cubensis; Pythium species such as, for example, Pythium ultimum; leaf spot diseases and leaf wilt caused by, for example, Alternaria species such as, for example, Alternaria solani; Cercospora species such as, for example, Cercospora arachidicola; Cladosporium species such as, for example, Cladosporium cucumerinum; Cochliobolus species such as, for example, Cochliobolus sativus (conidial form: Drechslera, syn: Helminthosporium);

Colletotrichum species such as, for example, Colletotrichum lindemuthanium; Cycloconium species such as, for example, Cycloconium oleaginum; Diaporthe species such as, for example, Diaporthe citri;

Elsinoe species such as, for example, Elsinoe fawcettii; Gloeosporium species such as, for example, Gloeosporium laeticolor; Glomerella species such as, for example, Glomerella cingulata; Guignardia species such as, for example, Guignardia bidwelli; Leptosphaeria species such as, for example, Leptosphaeria maculans; Magnaporthe species such as, for example, Magnaporthe grisea;

Mycosphaerella species such as, for example, Mycosphaerella graminicola; Phaeosphaeria species such as, for example, Phaeosphaeria nodorum; Pyrenophora species such as, for example, Pyrenophora teres;

Ramularia species such as, for example, Ramularia collo-cygni; Rhynchosporium species such as, for example, Rhynchosporium secalis; Septoria species such as, for example, Septoria apii;

Typhula species such as, for example, Typhula incarnata; Venturia species such as, for example, Venturia inaequalis; root and stalk diseases, caused by, for example, Corticium species such as, for example, Corticium graminearum; Fusarium species such as, for example, Fusarium oxysporum;

Gaeumannomyces species such as, for example, Gaeumannomyces graminis; Rhizoctonia species such as, for example, Rhizoctonia solani; Tapesia species such as, for example, Tapesia acuformis;

Thielaviopsis species such as, for example, Thielaviopsis basicola; ear and panicle diseases (including maize cobs), caused by, for example, Alternaria species such as, for example, Alternaria spp.;

Aspergillus species such as, for example, Aspergillus flavus; Cladosporium species such as, for example, Cladosporium spp.; Claviceps species such as, for example, Claviceps purpurea; Fusarium species such as, for example, Fusarium culmorum; Gibberella species such as, for example, Gibberella zeae; Monographella species such as, for example, Monographella nivalis;

diseases caused by smuts such as, for example, Sphacelotheca species such as, for example, Sphacelotheca reiliana; Tilletia species such as, for example, Tilletia caries; Urocystis species such as, for example, Urocystis occulta; Ustilago species such as, for example, Ustilago nuda; fruit rot caused by, for example, Aspergillus species such as, for example, Aspergillus flavus; Botrytis species such as, for example, Botrytis cinerea; Penicillium species such as, for example, Penicillium expansum; Sclerotinia species such as, for example, Sclerotinia sclerotiorum;

Verticillium species such as, for example, Verticillium alboatrum; seed- and soil-borne rots and wilts, and seedling diseases, caused by, for example, Fusarium species such as, for example, Fusarium culmorum; Phytophthora species such as, for example, Phytophthora cactorum; Pythium species such as, for example, Pythium ultimum; Rhizoctonia species such as, for example, Rhizoctonia solani;

Sclerotium species such as, for example, Sclerotium rolfsii; cankers, galls and witches' broom diseases, caused by, for example, Nectria species such as, for example, Nectria galligena; wilts caused by, for example, Monilinia species such as, for example, Monilinia laxa; deformations of leaves, flowers and fruits, caused by, for example, Taphrina species such as, for example, Taphrina deformans; degenerative diseases of woody species, caused by, for example, Esca species such as, for example, Phaemoniella clamydospora; flower and seed diseases, caused by, for example, Botrytis species such as, for example, Botrytis cinerea; diseases of plant tubers caused by, for example, Rhizoctonia species such as, for example, Rhizoctonia solani; diseases caused by bacterial pathogens such as, for example, Xanthomonas species such as, for example, Xanthomonas campestris pv. oryzae; Pseudomonas species such as, for example, Pseudomonas syringae pv. lachrymans; Erwinia species such as, for example, Erwinia amylovora.

The present OD (Oil Dispersion) formulation comprising bioactive amount of (A) Spinetoram; and (B) at least one more of active ingredients selected from class of an insecticides; or a fungicides; or a plant health additive; or combination thereof provides:
Improved leaf penetration of spray droplets, retard evaporation loss and enhance the absorption of active ingredients;
Increase spreading properties on leaf surfaces, better wetting of waxy leaf surfaces;
Increase penetration of active ingredients into the insect cuticles and insects with waxy cuticles like mealybug and scale insects;
Improve leaf penetration of spray droplets and enhanced wetting of leaf surfaces;
Improve rain fast properties.

Further present invention further provides increases in the synergistic activities between active ingredients.

The present novel synergistic OD formulation improves the residual control i.e. enhance the duration of control of insect-pests, mites and fungal and bacterial diseases.

The inventor has found that with the novel recipe of OD formulation, we can reduce the doses of active ingredients and thereby minimizing the pesticidal load into the environment.

The present novel OD formulations composition is without or reduced amount of aromatic solvent, so it's safe to the applicator and reducing the loading of aromatic solvent into the environment.

Oil Dispersion formulation of the present invention comprises carrier or solvent as Pongamia, Palm or jojoba oil. Due to High flash point (smoke points) of Pongamia (>220 Celcius), Palm oil (>240° C.), Jojoba oil (>290° C.), the novel recipe of OD formulations are more stable and safer for storage at elevated temperature. Therefore the present novel recipe of OD formulations has thermal and chemical stability over a broad range of conditions.

The novel recipe of OD formulations has better pourability, so it will minimize the wastage. The novel recipe of OD formulations are stable with wider pH range.

In the composition of the present OD formulation, we can reduces the toxicity hazards to the applicators, i.e. improves the safety of applicators at the time of handling and spraying the pesticides.

The process for preparing the present synergistic oil dispersion formulation can be modified accordingly by any person skilled in the art based on the knowledge of manufacturing the formulation. However all such variations and modifications are covered by the scope of the present invention.

The composition of the present invention in addition to bioactive amounts of active ingredients further comprises inactive excipients including but not limited to Super Wetting-spreading-penetrating agent, carrier or solvent, dispersant or dispersing agent, emulsifying agent, anti-freezing agent, anti-foam agent, preservatives and buffering agent.

Examples of super wetting-spreading-penetrating agent used herein for present OD (Oil Dispersion) formulation include but not limited to Polyalkyleneoxide modified Heptamethyl trisiloxane (Modified trisiloxane).

### Polyalkyleneoxide Modified Heptamethyltrisiloxane:

Polyalkyleneoxide modified heptamethyltrisiloxane can improve the penetration effect of pesticides and reduce the spray volume. It is used in the fields of pesticides, herbicides, insecticides, acaricides, fungicides, plant growth regulating agents, and other aspects. (Polyalkyleneoxide modified heptamethyltrisiloxane, a registered product of GE Silicones)

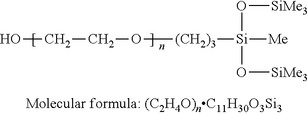

Examples of Carrier or solvents used herein for present Oil dispersion (OD) formulation include but not limited to Pongamia/karanja/karanj (Millettia pinnata/Pongamia pinnata/Pongamia glabra) oil alone; or Palm (Elaeis spp.) oil (Palm oil and palm kernel oil) alone; or Blend of Pongamia oil and palm oil; or Blend of Pongamia oil and Jojoba (Simmondsia chinensis); or Blend of Palm oil and Jojoba oil; or Blend of Pongamia oil and vegetable oil; or Blend of Palm oil and vegetable oil; or Blend of Pongamia oil, Palm oil and vegetable oil; the vegetable oil may be any one or mixture of two or more selected from soybean (Glycine max) oil, groundnut (Arachis hypogaea) oil, rapeseed (Brassica napus subspecies) oil, mustard (Brassica juncea) oil, sesame (Sesamum indicum) oil, Corn (Zea mays) oil, rice (Oryza sativa) bran oil, castor (Ricinum communis) seed oil, cotton (Gossypium hirsutum) seed oil, linseed (Linum usitatissimum), coconut (Cocos nucifera) oil, Kapok (Ceiba pentandra) oil, Papaya (Carica papaya) seed oil, Tea seed (Camellia oleifera) oil, sunflower (Helianthus annuus) oil, safflower (Carthamus tinctorius) seed oil, Eucalyptus (Eucalyptus globulus) oil, Olive (Olea europaea) oil, Jatropha (Jatropha curcas) oil, Garlic acid (Allium sativum), Ginger oil (Zingiber officinale), D-limonene, Citronella oil or Ceylon ironwood (Mesua ferrea) oil, Mahua (Madhuca longifolia) oil.

All the solvents or combination or blend thereof, used hereby for the present OD formulation may be present in their alkylated or ethoxylated or epoxylated or esterified form. All the said oils used as a carrier or diluent are procured from the vendor based in Gujarat State.

Examples of Carrier or solvents used herein for present Oil dispersion (OD) formulation include but not limited to Pongamia/karanja/karanj (Millettia pinnata/Pongamia pinnata/Pongamia glabra) oil alone; or Palm (Elaeis spp.) oil (Palm oil and palm kernel oil) alone; or Blend of Pongamia oil and palm oil; or Blend of Pongamia oil and Jojoba (Simmondsia chinensis); or Blend of Palm oil and Jojoba oil; or Blend of Pongamia oil and vegetable oil; or Blend of Palm oil and vegetable oil; or Blend of Pongamia oil, Palm oil and vegetable oil.

### Pongamia Oil/Karanja Oil:

Pongamia oil is derived from the seeds of the Millettia pinnata tree, which is native to tropical and temperate Asia. Millettia pinnata, also known as Pongamia pinnata or Pongamia glabra, is common throughout Asia and thus has many different names in different languages, many of which have come to be used in English to describe the seed oil derived from M. pinnata; Pongamia is often used as the generic name for the tree and is derived from the genus the tree was originally placed in. Other names for this oil include honge oil, kanuga oil, karanja oil, and pungai oil.

Pongamia oil is extracted from the seeds by expeller pressing, cold pressing, or solvent extraction. The oil is yellowish-orange to brown in colour. It has a high content of triglycerides, and its disagreeable taste and odour are due to bitter flavonoid constituents including karanjin, pongamol, tannin and karanjachromene. The physical properties of crude pongamia oil are as flash point of the pongamia oil is 225° C.

Its fruits are used in abdominal remedies. Its seeds are used in tumor treatment. Oil is used for curing rheumatism. Leaves are used against Micrococcus. Their leaves juices are used for the treatment of diarrhea cold and cough. It has curative effect for leucoderma and itches. Its oil is used as a lubricant, water paint binder. Utilization of Seed Cake as a Manure for having the proper N, P & K content and ratio. As a material for biogas (Methane) production. As a Material for Producing Proteins for Food, Pharmaceutical and Industrial Applications by Chemical and Biochemical Technologies. Production of Soluble Fibers for Food Uses.

It is medium sized tree and is found throughout India. The tree is drought resistant. Major producing countries are East Indies, Philippines, and India. The oil content varies from 27-39%. Its cake is used as pesticide and fertilizer. The deoiled cake when applied to soil, has pesticidal value, especially against nematodes and also helps in improving soil fertility. Karanja is often planted in home steads as a shade or ornamental tree and in avenue planting along roadside and canals. It is preferred species help in controlling soil erosion and binding sand dunes due to its dense network of lateral roots.

The persistence of karanj is greater than other tested botanical insecticides. The dosages at 1 and 2% of karanj oil give better control of insect pests compared with lower concentrations. Karanj oil and karanjin shows greater biological activity than other karanj extracts. The karanj oil shows good synergistic effect with a number of chemical insecticides. Therefore, karanj has great potential to be used as biopesticide because of its antifeedant; oviposition deterrent, ovicidal, roachicidal, juvenile hormone activity and insecticidal properties against a wide range of insect pests [Mukesh Kumar a & Ram Singh, Department of Entomology, Potential of Pongamia glabra Vent as an Insecticide of Plant Origin, CCS Haryana, Agricultural University, Hisar, 125 004, India, Published online: 24 Apr. 2012].

Botanical pesticides are also very potent insecticides and, due to their composition, they can help to fight the global problem of insects developing resistance to insecticides. Insecticides based on karanja oil shows efficiency against L. decemlineata larvae at different concentrations [Katerina Kovarikova and Roman Pavela; United Forces of Botanical Oils:

Efficacy of Neem and Karanja Oil against Colorado Potato Beetle under Laboratory Conditions; Plants 2019, 8, 608; doi:10.3390/plants8120608].

### Palm Oil

Palm oil is an edible vegetable oil derived from the mesocarp (reddish pulp) of the fruit of the oil palms, primarily the African oil palm Elaeis guineensis, and to a lesser extent from the American oil palm Elaeis oleifera and the Maripa palm Attalea maripa.

The use of palm oil in food and beauty products has attracted the concern of environmental groups; the high oil yield of the trees has encouraged wider cultivation, leading to the clearing of forests in parts of Indonesia and Malaysia to make space for oil-palm monoculture. This has resulted in significant acreage losses of the natural habitat of the three surviving species of orangutan. One species in particular, the Sumatran orangutan, has been listed as critically endangered.

PME (Palm-based Methyl Esters) as carrier solvents appear to enhance pesticide efficacy, which may allow for a reduction in dosage or frequency of application, help to control adverse effects and reduce the cost spent on pesticides. Therefore, PME as a carrier solvent in pesticide formulations is a promising prospect for the agrochemical industry [Sumaiyah Megat Nabil Mohsin; Ismail Ab Raman; Zafarizal Aldrin Azizul Hasan and Zainab Idris; Palm-based Methyl Esters as Carrier Solvents in Pesticide Formulations, Technical Report, January 2018, Page no. 32-38].

### Jojoba Oil:

Jojoba oil is the liquid produced in the seed of the Simmondsia chinensis (jojoba) plant, a shrub, which is native to southern Arizona, southern California, and northwestern Mexico. The oil makes up approximately 50% of the jojoba seed by weight. The terms “jojoba oil” and “jojoba wax” are often used interchangeably because the wax visually appears to be a mobile oil, but as a wax it is composed almost entirely (˜97%) of mono-esters of long-chain fatty acids and alcohols (wax ester), accompanied by only a tiny fraction of triglyceride esters. This composition accounts for its extreme shelf-life stability and extraordinary resistance to high temperatures, compared with true vegetable oils.

Jojoba oil shows an insecticidal activity. At lower as well has higher concentration jojoba oil has insecticidal properties and can be use plant protection management [Tahany, R. Abd E1-Zaher; Biological Activity of Four Plant Oils in the Form of Nano Products on the Larvae of Cotton leaf worm; Middle East Journal of Applied Sciences; Volume: 07, Issue: 02, April-June 2017, Pages: 239-249].

### Vegetable Oil:

The term “vegetable oil” can be narrowly defined as referring only to substances that are liquid at room temperature, or broadly defined without regard to a substance's state (liquid or solid) at a given temperature. While a large majority of the entries in this list fit the narrower of these definitions, some do not qualify as vegetable oils according to all understandings of the term.

Vegetable oils are triglycerides extracted from plants. Some of these oils have been part of human culture for millennia. Edible vegetable oils are used in food, both in cooking and as supplements. Many oils, edible and otherwise, are burned as fuel, such as in oil lamps and as a substitute for petroleum-based fuels. Some of the many other uses include wood finishing, oil painting, and skin care.

Vegetable oils, or vegetable fats, are oils extracted from seeds or from other parts of fruits. Like animal fats, vegetable fats are mixtures of triglycerides. Soybean oil, grape seed oil, and cocoa butter are examples of fats from seeds. Olive oil, palm oil, and rice bran oil are examples of fats from other parts of fruits. In common usage, vegetable oil may refer exclusively to vegetable fats which are liquid at room temperature. Vegetable oils are usually edible; non-edible oils derived mainly from petroleum are termed mineral oils.

Most, but not all vegetable oils are extracted from the fruits or seeds of plants. For instance, palm oil is extracted from palm fruits, while soybean oil is extracted from soybean seeds. Vegetable oils may also be classified by grouping oils extracted from similar plants, such as “nut oils”. Although most plants contain some oil, only the oil from certain major oil crops complemented by a few dozen minor oil crops is widely used and traded.

Oils from plants are used for several different purposes. Edible vegetable oils may be used for cooking, or as food additives. Many vegetable oils, edible and otherwise, are burned as fuel, for instance as a substitute for petroleum-based fuels. Some may be also used for cosmetics, medical purposes, wood finishing, oil painting, formulation ingredient in many pharmaceutical or agricultural formulations and other industrial purposes.

The vegetable Oil for preparing blend with karanj oil or palm oil or jojoba oil used herein as solvent or carrier for present Oil dispersion (OD) formulation include but not limited to any one or mixture of two or more selected from soybean (Glycine max) oil, groundnut (Arachis hypogaea) oil, rapeseed (Brassica napus subspecies) oil, mustard (Brassica juncea) oil, sesame (Sesamum indicum) oil, Corn (Zea mays) oil, rice (Oryza sativa) bran oil, castor (Ricinum communis) seed oil, cotton (Gossypium hirsutum) seed oil, linseed (Linum usitatissimum), coconut (Cocos nucifera) oil, Kapok (Ceiba pentandra) oil, Papaya (Carica papaya) seed oil, Tea seed (Camellia oleifera) oil, sunflower (Helianthus annuus) oil, safflower (Carthamus tinctorius) seed oil, Eucalyptus (Eucalyptus globulus) oil, Olive (Olea europaea) oil, Jatropha (Jatropha curcas) oil, Garlic acid (Allium sativum), Ginger oil (Zingiber officinale), D-limonene, Citronella oil or Ceylon ironwood (Mesua ferrea) oil, Mahua (Madhuca longifolia) oil.

Examples of cosolvents used herein for present Oil dispersion (OD) formulation include but not limited to Cyclohexanone, Acetophenone, NMP (N-methyl pyrrolidinone), Dimethyl sulfoxide, Benzyl alcohol, Butanol, N-octanol, N-Propanol, 2-ethyl hexanol, Tetrahydro furfuryl alcohol, Isophorone, Fatty acid dimethyl amide, 2-hexylethyl lactate, Propylene carbonate.

A dispersant or a dispersing agent is a substance which adsorbs onto the surface of particles and helps to preserve the state of dispersion of the particles and prevents them from re-aggregating. Dispersants are added to agrochemical formulations to facilitate dispersion and suspension during manufacture, and to ensure the particles re-disperse into water in a spray tank. They are widely used in wettable powders, suspension concentrates and water-dispersible granules. Surfactants that are used as dispersants have the ability to adsorb strongly onto a particle surface and provide a charged or steric barrier to re-aggregation of particles. The most commonly used surfactants are anionic, non-ionic, or mixtures of the two types. For wettable powder formulations, the most common dispersants are sodium lingo sulphonates. In recent years, new types of very high molecular weight polymeric surfactants have been developed as dispersants. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces.

Examples of dispersing agent used herein for used herein for present OD (Oil Dispersion) formulation include but not limited to preparation of condensed naphthalene sulfonate, propoxylated Ethoxylated copolymer monoalkylether (ethylhexanol), alkyl sulfonates, alkyl benzene sulfonates, alkyl aryl sulfonates, alkylphenolalkoxylates, tristyrylphenol ethoxylates, natural or synthetic fatty ethoxylate alcohols, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers), fatty acid-polyalkylene glycol condensates, polyamine-fatty acid condensates, polyester condensates, salts of polyolefin condensates, sodium ligno sulfonate, sodium ploycarboxylate, EO/PO based copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide.

Antifoaming agent for the present formulation is selected from various compounds and selectively used according to the formulation. Generally, there are two types of antifoam agents, namely silicones and non-silicones. Silicones are usually aqueous emulsions of dimethyl poly siloxane while the non-silicone anti-foam agents are water-insoluble oils, such as octanol and nonanol, or silica. In both cases, the function of the anti-foam agent is to displace the surfactant from the air-water interface.

Examples of Antifoaming agent used herein for present Oil dispersion (OD) formulation include but not limited to silicone oil, silicone compound, C10˜C20 saturated fat acid compounds or C8˜C10 aliphatic alcohols compound, silicone antifoam emulsion, dimethyl siloxane, poly dimethyl siloxane, vegetable oil based antifoam, tallow based fatty acids, polyalkylene oxide modified polydimethylsiloxane.

Examples of Anti-freezing agent used herein for present Oil dispersion (OD) formulation include but not limited ethylene glycol, propane diols, glycerine or the urea, glycol (Monoethylene glycol, Diethylene glycol, Polypropylene glycol, Polyethylene glycol), glycerine, urea, magnesium sulfate heptahydrate, sodium chloride.

Preservative used herein for the present Oil dispersion (OD) formulation include but not limited to 1,2-benzisothiazolin-3(2H)-one, sodium salt, sodium benzoate, 2-bromo-2-nitropropane-1,3-diol, formaldehyde, sodium o-phenylphenate, 5-chloro-2-methyl-4-isothiazolin-3-one & 2-methyl-4-isothiazolin-3-one, Butyl hydroxyl toluene.

Emulsifying agent used herein for the present Oil dispersion (OD) formulation includes but not limited to castor oil ethoxylates, alcohol ethoxylates, fatty acid ethoxylates, sorbitan ester ethoxylates, ethoxylated sorbitol oleates, sulphosuccinate, calcium salts of dodecylbenzene sulphonate, alkylammonium salts of alkylbenzene sulphonate, alkylsulphosuccinate salts, ethylene oxide-propylene oxide block copolymers, ethoxylated alkylamines, ethoxylated alkyl phenols, polyoxyethylenesorbitan monolaurate.

Stabilizers or stabilizing agent used herein for the present Oil dispersion (OD) formulation includes but not limited to hectorite clay, aluminum magnesium silicate, bentonite clay, silica, attapulgite clay.

Examples of Buffering agent used herein for the present Oil dispersion (OD) formulation include but not limited to Citric acid, sodium carbonate, sodium bicarbonate, sulphuric acid, hydrochloric acid, sodium hydroxide, potassium hydroxide, acetic acid, sorbic acid.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. The invention shall now be described with reference to the following specific examples. It should be noted that the example(s) appended below illustrate rather than limit the invention, and that those skilled in the art will be able to design many alternative embodiments without departing from the scope of the present invention.

These and other aspects of the invention may become more apparent from the examples set forth herein below. These examples are provided merely as illustrations of the invention and are not intended to be construed as a limitation thereof.

### Example 1

### Procedure: Manufacturing Process of Oil Dispersion (OD) Formulation

Preparation of Oil dispersion (OD) formulation:

| Part A | Preparation of the liquid premix |
|---|---|
| Step 1 | Charge Vegetable oil (pongamia oil or palm oil or pongamia oil + palm oil |
| | or pongamia oil + jojoba oil or palm oil + jojoba oil or pongamia |
| | oil + vegetable oil or paml oil + vegetable oil or pongamia oil + palm |
| | oil + vegetable oil) or solvent or both into a vessel with anchor stirrer. |
| Step 2 | Under stirring, add the emulsifier/super wetting-spreading-penetrating |
| | agent (Polyalkyleneoxide modified Heptamethyl trisiloxane) and |
| | dispersing agent and stir until all ingredients are dissolved completely. |
| Part B | Preparation of the slurry |
| Step 1 | Now, charge the liquid premix into a second vessel, equipped with a |
| | cooling and heating device and a high shear stirrer. |
| Step 2 | Add the active ingredient(s) and homogenize thoroughly. Pre-mill this |
| | mixture and finally mill it using a bead mill/sand mill/attritor to achieve a |
| | particle size distribution as required by the specification. |
| Part C | Preparation of the Thickener gel |
| Step 1 | Charge the remaining oil or solvent to the vessel, equipped with a high |
| | shear stirrer. |
| Step 2 | Add gradually the thickener which is organophilic clay, maintaining high- |
| | shear mixing throughout. Stirring is continued until thoroughly mixed. |
| Step 3 | Under stirring, the thickener activating agent propylene carbonate is |
| | added. Allow the gel to swell whilst maintaining mixing. |
| Part D | Preparation of the final formulation |
| Step 1 | Now add the thickener gel or silica and disperse the mixture by using a |
| | high shear stirrer. |
| Step 2 | Check the finished formulation to specification. |
| Step 3 | After approval, material is packed in required pack sizes. |

### Example 2

### Example 2A: Spinetoram 4%+Tolfenpyrad 12% OD (Novel OD)

| | Content % |
|---|---|
| Chemical composition | (w/w) |
| Spinetoram a.i. | 4.00 |
| Tolfenpyrad a.i. | 12.00 |
| Super wetting-spreading-penetrating agent-Polyalkyleneoxide | 5.00 |
| modified Heptamethyl trisiloxane | |
| Solvent-Methyl ester of pongamia oil | 38.05 |
| Cosolvent-Cyclohexanone | 10.00 |
| Dispersing agent I-Preparation of condensed naphthalene | 0.50 |
| sulfonate | |
| Dispersing Agent II-Propoxylated Ethoxylated copolymer | 15.00 |
| monoalkylether (ethylhexanol) | |
| Antifoam-Polydimethylsiloxane | 0.05 |
| Antifreezing agent-Polypropylene glycol | 5.00 |
| Preservative-Butyl hydroxyl toluene | 0.20 |
| Stabilizer-Silica | 2.00 |
| Emulsifier-Ethoxylated sorbitol oleates | 10.00 |
| Buffering agent-Citric acid | 0.20 |
| Total | 100.00 |

### Example 2B: Spinetoram 4%+Tolfenpyrad 12% OD (Conventional OD)

| | Content % |
|---|---|
| Chemical composition | (w/w) |
| Spinetoram a.i. | 4.00 |
| Tolfenpyrad a.i. | 12.00 |
| Wetting agent-Ethoxylated fatty alcohols | 5.00 |
| Solvent-Sunflower oil | 38.05 |
| Cosolvent-Cyclohexanone | 10.00 |
| Dispersing agent I-Preparation of condensed naphthalene | 0.50 |
| sulfonate | |
| Dispersing Agent II-Propoxylated Ethoxylated copolymer | 15.00 |
| monoalkylether (ethylhexanol) | |
| Antifoam-Polydimethylsiloxane | 0.05 |
| Antifreezing agent-Polypropylene glycol | 5.00 |
| Preservative-Butyl hydroxyl toluene | 0.20 |
| Emulsifier-Ethoxylated sorbitol oleates | 10.00 |
| Buffering agent-Citric acid | 0.20 |
| Total | 100.00 |

### Example 3

### Example 3A

### Storage Stability-Spinetoram 4%+Tolfenpyrad 12% OD (Novel OD)

| | | | Laboratory | | | | |
|---|---|---|---|---|---|---|---|
| | | | storage for | | | | |
| | | | 14 days | | Room temperature storage | | |
| | Specification | | At 54 ± | At 0 ± | 1 | 6 | 12 |
| Parameters | (in house) | Initial | 2° C. | 2° C. | month | months | months |
| Spinetoram | 3.80 to | 4.30 | 4.15 | 4.28 | 4.30 | 4.25 | 4.15 |
| content percent | 4.40 | | | | | | |
| by mass | | | | | | | |
| Tolfenpyrad | 11.40 to | 12.50 | 12.25 | 12.45 | 12.50 | 12.40 | 12.25 |
| content percent | 12.60 | | | | | | |
| by mass | | | | | | | |
| Spinetoram | 80 | 98.70 | 97.80 | 98.60 | 98.70 | 98.50 | 98.00 |
| suspensibility | | | | | | | |
| percent min. | | | | | | | |
| Tolfenpyrad | 80 | 98.20 | 96.80 | 98.00 | 98.00 | 97.50 | 97.00 |
| suspensibility | | | | | | | |
| percent min. | | | | | | | |
| pH range (1% | 5.0 to | 6.00 | 6.15 | 6.00 | 6.10 | 6.15 | 6.20 |
| aq. Suspension) | 7.5 | | | | | | |
| Pourability | 95% | 99.20 | 98.80 | 99.00 | 99.20 | 99.00 | 98.80 |
| | min. | | | | | | |
| Viscosity at | 350-800 | 600 | 610 | 605 | 610 | 615 | 620 |
| spindle no. 62, | cps | | | | | | |
| 20 rpm | | | | | | | |
| Particle size | D50 < 3, | 2.2, | 2.4, | 2.5, | 2.2, | 2.4, | 2.5, |
| (micron) | D90 < 10 | 8.5 | 8.6 | 8.8 | 8.5 | 8.6 | 8.8 |
| Persistent foam | 60 | nil | 2 | nil | nil | 2 | nil |
| ml (after 1 | | | | | | | |
| minute) max. | | | | | | | |
| Spreading | Min 20 mm. | 35 | 33 | 34 | 35 | 35 | 34.6 |
| diameter (1% | | | | | | | |
| solution) | | | | | | | |

The novel OD formulation recipe of Spinetoram 4%+Tolfenpyrad 12% meets the all inhouse specifications for storage stability studies in laboratory (at 54±2 C & At 0±2° C. for 14 days) and room temperature (for 12 months).

### Example 3B

### Storage Stability—Spinetoram 4%+Tolfenpyrad 12% OD (Conventional OD)

| | | | Laboratory | | | | |
|---|---|---|---|---|---|---|---|
| | | | storage for | | | | |
| | | | 14 days | | Room temperature storage | | |
| | Specification | | At 54 ± | At 0 ± | 1 | 6 | 12 |
| Parameters | (in house) | Initial | 2° C. | 2° C. | month | months | months |
| Spinetoram | 3.80 to | 4.30 | 4.15 | 4.28 | 4.30 | 4.25 | 4.15 |
| content percent | 4.40 | | | | | | |
| by mass | | | | | | | |
| Tolfenpyrad | 11.40 to | 12.50 | 12.25 | 12.45 | 12.50 | 12.40 | 12.25 |
| content percent | 12.60 | | | | | | |
| by mass | | | | | | | |
| Spinetoram | 80 | 98.70 | 97.00 | 98.50 | 98.50 | 97.20 | 96.80 |
| suspensibility | | | | | | | |
| percent min. | | | | | | | |
| Tolfenpyrad | 80 | 98.20 | 96.00 | 98.00 | 98.00 | 97.20 | 96.20 |
| suspensibility | | | | | | | |
| percent min. | | | | | | | |
| pH range (1% | 5.0 to | 6.00 | 6.15 | 6.00 | 6.10 | 6.20 | 6.30 |
| aq. Suspension) | 7.5 | | | | | | |
| Pourability | 95% | 95.20 | 95.80 | 93.60 | 95.20 | 95.00 | 93.50 |
| | min. | | | | | | |
| Viscosity at | 350-800 | 650 | 690 | 730 | 680 | 700 | 760 |
| spindle no. 62, | cps | | | | | | |
| 20 rpm | | | | | | | |
| Particle size | D50 < 3, | 2.2, | 2.5, | 2.4, | 2.2, | 2.4, | 2.5, |
| (micron) | D90 < 10 | 8.6 | 10.4 | 9.6 | 8.6 | 9.5 | 10.6 |
| Persistent foam | 60 | nil | 2 | nil | nil | 2 | nil |
| ml (after 1 | | | | | | | |
| minute) max. | | | | | | | |
| Spreading | Min 20 mm. | 12 | 11 | 12 | 11.5 | 10.5 | 10 |
| diameter (1% | | | | | | | |
| solution) | | | | | | | |

Storage stability of Spinetoram 4%+Tolfenpyrad 12% OD (Conventional OD) shows poor pourability (93.5%), increase in particle size (D90, 10.6) at 12 months of room storage and also has lower spreading properties (10 mm).

### Example 4

### Example 4A: Spinetoram 4%+Diafenthiuron 24% OD (Novel OD)

| | Content % |
|---|---|
| Chemical composition | (w/w) |
| Spinetoram a.i. | 4.00 |
| Diafenthiuron a.i. | 24.00 |
| Super wetting-spreading-penetrating agent-Polyalkyleneoxide | 5.00 |
| modified Heptamethyl trisiloxane | |
| Solvent-Blend of Methyl ester of pongamia oil and sunflower | 26.05 |
| oil | |
| Cosolvent-Cyclohexanone | 10.00 |
| Dispersing agent I-Preparation of condensed naphthalene | 0.50 |
| sulfonate | |
| Dispersing Agent II-Propoxylated Ethoxylated copolymer | 15.00 |
| monoalkylether (ethylhexanol) | |
| Antifoam-Polydimethylsiloxane | 0.05 |
| Antifreezing agent-Polypropylene glycol | 5.00 |
| Preservative-Butyl hydroxyl toluene | 0.20 |
| Stabilizer-Silica | 2.00 |
| Emulsifier-Ethoxylated sorbitol oleates | 10.00 |
| Buffering agent-Citric acid | 0.20 |
| Total | 100.00 |

### Example 4B: Spinetoram 4%+Diafenthiuron 24% OD (Conventional OD)

| | Content % |
|---|---|
| Chemical composition | (w/w) |
| Spinetoram a.i. | 4.00 |
| Diafenthiuron a.i. | 24.00 |
| Wetting agent-Ethoxylated sorbitol oleates | 5.00 |
| Solvent-Fatty acids glycerides | 26.05 |
| Cosolvent-Cyclohexanone | 10.00 |
| Dispersing agent I-Preparation of condensed naphthalene | 0.50 |
| sulfonate | |
| Dispersing Agent II-Propoxylated Ethoxylated copolymer | 15.00 |
| monoalkylether (ethylhexanol) | |
| Antifoam-Polydimethylsiloxane | 0.05 |
| Antifreezing agent-Polypropylene glycol | 5.00 |
| Preservative-Butyl hydroxyl toluene | 0.20 |
| Emulsifier-Ethoxylated sorbitol oleates | 10.00 |
| Buffering agent-Citric acid | 0.20 |
| Total | 100.00 |

### Example 5

### Example 5A

### Storage Stability-Spinetoram 4%+Diafenthiuron 24% OD (Novel OD)

| | | | Laboratory | | | | |
|---|---|---|---|---|---|---|---|
| | | | storage for | | | | |
| | | | 14 days | | Room temperature storage | | |
| | Specification | | At 54 ± | At 0 ± | 1 | 6 | 12 |
| Parameters | (in house) | Initial | 2° C. | 2° C. | month | months | months |
| Spinetoram | 3.80 to | 4.30 | 4.10 | 4.25 | 4.30 | 4.20 | 4.10 |
| content percent | 4.40 | | | | | | |
| by mass | | | | | | | |
| Diafenthiuron | 23.28 to | 25.00 | 24.20 | 24.80 | 25.00 | 24.50 | 24.20 |
| content percent | 25.20 | | | | | | |
| by mass | | | | | | | |
| Spinetoram | 80 | 97.80 | 97.00 | 97.40 | 97.80 | 97.40 | 97.20 |
| suspensibility | | | | | | | |
| percent min. | | | | | | | |
| Diafenthiuron | 80 | 97.20 | 96.00 | 97.00 | 97.20 | 97.00 | 97.20 |
| suspensibility | | | | | | | |
| percent min. | | | | | | | |
| pH range (1% | 5.0 to | 6.50 | 6.30 | 6.50 | 6.50 | 6.40 | 6.30 |
| aq. Suspension) | 7.5 | | | | | | |
| Pourability | 95% | 98.50 | 98.00 | 98.30 | 98.50 | 98.30 | 98.10 |
| | min. | | | | | | |
| Viscosity at | 350-800 | 600 | 620 | 610 | 600 | 605 | 610 |
| spindle no. 62, | cps | | | | | | |
| 20 rpm | | | | | | | |
| Particle size | D50 < 3, | 2.2, | 2.4, | 2.3, | 2.2, | 2.2, | 2.3, |
| (micron) | D90 < 10 | 8.2 | 8.4 | 8.3 | 8.2 | 8.3 | 8.3 |
| Persistent foam | 60 | nil | 2 | nil | nil | Nil | 2 |
| ml (after 1 | | | | | | | |
| minute) max. | | | | | | | |
| Spreading | Min 20 mm. | 38.4 | 34.6 | 37.6 | 38.3 | 38 | 37.2 |
| diameter (1% | | | | | | | |
| solution) | | | | | | | |

The novel OD formulation recipe of Spinetoram 4%+Diafenthiuron 24% meets the all inhouse specifications for storage stability studies in laboratory (at 54±2 C & At 0±2° C. for 14 days) and room temperature (for 12 months).

### Example 5B

### Storage Stability-Spinetoram 4%+Diafenthiuron 24% OD (Conventional OD)

| | | | Laboratory | | | | |
|---|---|---|---|---|---|---|---|
| | | | storage for | | | | |
| | | | 14 days | | Room temperature storage | | |
| | Specification | | At 54 ± | At 0 ± | 1 | 6 | 12 |
| Parameters | (in house) | Initial | 2° C. | 2° C. | month | months | months |
| Spinetoram | 3.80 to | 4.30 | 4.05 | 4.20 | 4.20 | 4.12 | 4.05 |
| content percent | 4.40 | | | | | | |
| by mass | | | | | | | |
| Diafenthiuron | 23.28 to | 25.00 | 24.00 | 24.70 | 24.50 | 24.30 | 24.00 |
| content percent | 25.20 | | | | | | |
| by mass | | | | | | | |
| Spinetoram | 80 | 95.40 | 94.60 | 95.30 | 95.20 | 94.60 | 94.00 |
| suspensibility | | | | | | | |
| percent min. | | | | | | | |
| Diafenthiuron | 80 | 95.00 | 94.20 | 94.70 | 94.80 | 94.20 | 93.40 |
| suspensibility | | | | | | | |
| percent min. | | | | | | | |
| pH range (1% | 5.0 to | 6.40 | 6.20 | 6.30 | 6.40 | 6.30 | 6.20 |
| aq. Suspension) | 7.5 | | | | | | |
| Pourability | 95% | 95.80 | 95.20 | 95.60 | 95.30 | 94.00 | 93.00 |
| | min. | | | | | | |
| Viscosity at | 350-800 | 590 | 660 | 630 | 620 | 690 | 740 |
| spindle no. 62, | cps | | | | | | |
| 20 rpm | | | | | | | |
| Particle size | D50 < 3, | 2.2, | 2.6, | 2.4 | 2.3, | 2.5, | 2.7, |
| (micron) | D90 < 10 | 8.2 | 8.8 | 8.5 | 8.3 | 9.5 | 10.6 |
| Persistent foam | 60 | 8 | 3 | 4 | 6 | 8 | 10 |
| ml (after 1 | | | | | | | |
| minute) max. | | | | | | | |
| Spreading | Min 20 mm. | 7 | 5.4 | 6.6 | 6.2 | 4.8 | 3.5 |
| diameter (1% | | | | | | | |
| solution) | | | | | | | |

Storage stability of Spinetoram 4%+Diafenthiuron 24% (Conventional OD) shows poor pourability (93%), increase in particle size (D90, 10.6) at 12 months of room storage and also has lower spreading properties.

### Example 6

### Spinetoram 10%+Chlorantraniliprole 6% OD (Novel OD)

| | Content % |
|---|---|
| Chemical composition | (w/w) |
| Spinetoram a.i. | 10.00 |
| Chlorantraniliprole a.i. | 6.00 |
| Super wetting-spreading-penetrating agent-Polyalkyleneoxide | 5.00 |
| modified Heptamethyl trisiloxane | |
| Solvent-Methyl ester of palm oil | 38.05 |
| Cosolvent-Cyclohexanone | 10.00 |
| Dispersing agent I-Preparation of condensed naphthalene | 0.50 |
| sulfonate | |
| Dispersing Agent II-Propoxylated Ethoxylated copolymer | 15.00 |
| monoalkylether (ethylhexanol) | |
| Antifoam-Polydimethylsiloxane | 0.05 |
| Antifreezing agent-Polypropylene glycol | 5.00 |
| Preservative-Butyl hydroxyl toluene | 0.20 |
| Stabilizer-Silica | 2.00 |
| Emulsifier-Ethoxylated sorbitol oleates | 10.00 |
| Buffering agent-Citric acid | 0.20 |
| Total | 100.00 |

The novel OD formulation recipe of Spinetoram 10%+Chlorantraniliprole 6% meets the all inhouse specifications for storage stability studies in laboratory (at 54±2 C & At 0±2° C. for 14 days) and room temperature (for 12 months).

### Example 7

### Spinetoram 8%+Fipronil 8% OD (Novel OD)

| | Content % |
|---|---|
| Chemical composition | (w/w) |
| Spinetoram a.i. | 8.00 |
| Fipronil a.i. | 8.00 |
| Super wetting-spreading-penetrating agent-Polyalkyleneoxide | 6.00 |
| modified Heptamethyl trisiloxane | |
| Solvent-Blend of Methyl ester of palm oil, sunflower oil | 37.05 |
| and jojoba oil | |
| Cosolvent-Cyclohexanone | 10.00 |
| Dispersing agent I-Preparation of condensed naphthalene | 0.50 |
| sulfonate | |
| Dispersing Agent II-Propoxylated Ethoxylated copolymer | 15.00 |
| monoalkylether (ethylhexanol) | |
| Antifoam-Polydimethylsiloxane | 0.05 |
| Antifreezing agent-Polypropylene glycol | 5.00 |
| Preservative-Butyl hydroxyl toluene | 0.20 |
| Stabilizer-Silica | 2.00 |
| Emulsifier-Ethoxylated sorbitol oleates | 10.00 |
| Buffering agent-Citric acid | 0.20 |
| Total | 100.00 |

The novel OD formulation recipe of Spinetoram 8%+Fipronil 8% meets the all inhouse specifications for storage stability studies in laboratory (at 54±2 C & At 0±2° C. for 14 days) and room temperature (for 12 months).

### Example 8

### Lists of Preferred Combinations of Novel OD (Oil Dispersion) Formulation

| | | Active ingredients | | Formula- |
|---|---|---|---|---|
| | | (%) | | tion |
| | | Com- | Com- | Strength |
| Compound A | Compound B | pound A | pound B | (%) |
| Spinetoram | Tolfenpyrad | 4 | 12 | 16.00 |
| Spinetoram | Abamectin | 4 | 0.9 | 4.90 |
| Spinetoram | Emamectin benzoate | 4 | 0.9 | 4.90 |
| Spinetoram | Chlorantraniliprole | 10 | 6 | 16.00 |
| Spinetoram | Cyantraniliprole | 10 | 10 | 20.00 |
| Spinetoram | Tetraniliprole | 10 | 8 | 18.00 |
| Spinetoram | Broflanilide | 10 | 2.5 | 12.50 |
| Spinetoram | Fluxametamide | 10 | 2.5 | 12.50 |
| Spinetoram | Isocycloseram | 10 | 10 | 20.00 |
| Spinetoram | Dichloromezotiaz | 10 | 7.5 | 17.50 |
| Spinetoram | Diafenthiuron | 4 | 24 | 28.00 |
| Spinetoram | Flonicamid | 8 | 10 | 18.00 |
| Spinetoram | Fipronil | 8 | 8 | 16.00 |
| Spinetoram | Spiropidion | 8 | 8 | 16.00 |
| Spinetoram | Spiroxamat | 8 | 6 | 14.00 |
| Spinetoram | Dimpropyridaz | 8 | 8 | 16.00 |
| Spinetoram | Methoxyfenozide | 4.5 | 12 | 16.50 |
| Spinetoram | Clothianidin | 8 | 12 | 20.00 |
| Spinetoram | Lambda cyhalothrin | 8 | 5 | 13.00 |
| Spinetoram | Fenpyroximate | 8 | 5 | 13.00 |
| Spinetoram | Hexythiazox | 8 | 5 | 13.00 |
| Spinetoram | Etoxazole | 8 | 6 | 14.00 |
| Spinetoram | Cyenopyrafen | 8 | 10 | 18.00 |

| | | | Active ingredients (%) | | | Formulation |
|---|---|---|---|---|---|---|
| | | | Compound | Compound | Compound | Strength |
| Compound A | Compound B | Compound C | A | B | C | (%) |
| Spinetoram | Diafenthiuron | Pyriproxyfen | 2.8 | 20 | 5 | 27.80 |
| Spinetoram | Diafenthiuron | Pyrifluquinazon | 2.8 | 20 | 4 | 26.80 |
| Spinetoram | Diafenthiuron | Spiropidion | 2.8 | 20 | 4 | 26.80 |
| Spinetoram | Diafenthiuron | Spiromesifen | 2.8 | 20 | 8 | 30.80 |
| Spinetoram | Diafenthiuron | Flonicamid | 2.8 | 20 | 4 | 26.80 |
| Spinetoram | Diafenthiuron | Tolfenpyrad | 2.8 | 20 | 6 | 28.80 |
| Spinetoram | Diafenthiuron | Abamectin | 2.8 | 20 | 0.6 | 23.40 |
| Spinetoram | Chlorantraniliprole | Spiropidion | 8 | 4 | 8 | 20.00 |
| Spinetoram | Chlorantraniliprole | Flonicamid | 8 | 4 | 10 | 22.00 |
| Spinetoram | Chlorantraniliprole | Dimpropyridaz | 8 | 4 | 10 | 22.00 |
| Spinetoram | Chlorantraniliprole | Tolfenpyrad | 8 | 4 | 15 | 27.00 |
| Spinetoram | Chlorantraniliprole | Abamectin | 8 | 4 | 1.5 | 13.50 |
| Spinetoram | Chlorantraniliprole | Emamectin benzoate | 8 | 4 | 1.5 | 13.50 |
| Spinetoram | Cyantraniliprole | Spiropidion | 8 | 8 | 8 | 24.00 |
| Spinetoram | Cyantraniliprole | Flonicamid | 8 | 8 | 10 | 26.00 |
| Spinetoram | Cyantraniliprole | Dimpropyridaz | 8 | 8 | 10 | 26.00 |
| Spinetoram | Cyantraniliprole | Tolfenpyrad | 8 | 8 | 15 | 31.00 |
| Spinetoram | Cyantraniliprole | Abamectin | 8 | 8 | 1.5 | 17.50 |
| Spinetoram | Cyantraniliprole | Emamectin benzoate | 8 | 8 | 1.5 | 17.50 |
| Spinetoram | Azoxystrobin | Difenoconazole | 5 | 10 | 5 | 20.00 |
| Spinetoram | Azoxystrobin | Fluxapyroxad | 5 | 10 | 5 | 20.00 |
| Spinetoram | Pyraclostrobin | Difenoconazole | 5 | 12 | 5 | 22.00 |
| Spinetoram | Pyraclostrobin | Fluxapyroxad | 5 | 12 | 5 | 22.00 |
| Spinetoram | Fluxapyroxad | Difenoconazole | 5 | 10 | 6 | 21.00 |
| Spinetoram | Tolfenpyrad | Gibberellic acid | 4 | 12 | 0.2 | 16.20 |
| Spinetoram | Abamectin | Gibberellic acid | 4 | 0.9 | 0.2 | 5.10 |
| Spinetoram | Emamectin benzoate | Gibberellic acid | 4 | 0.9 | 0.2 | 5.10 |
| Spinetoram | Chlorantraniliprole | Brassinolide | 10 | 6 | 0.1 | 16.10 |
| Spinetoram | Cyantraniliprole | Brassinolide | 10 | 10 | 0.1 | 20.10 |
| Spinetoram | Tetraniliprole | Brassinolide | 10 | 8 | 0.1 | 18.10 |

### Field Bio-Efficacy Studies:

The recipe of novel OD (Oil Dispersion) formulation of Spinetoram and insecticide were developed in the laboratory and field trials were carried out to study their benefits over conventional OD formulations.

The major objectives of studies are.
To study the bio efficacy of novel OD formulation vs conventional OD formulations
To study the residual control obtained by novel OD formulations vs conventional formulations
To study the synergism

A synergistic effect exists wherever the action of a combination of active ingredient is greater than the sum of the action of each of the components alone. Therefore, a synergistically effective amount or an effective amount of a synergistic composition or combination is an amount that exhibits greater pesticidal activity than the sum of the pesticidal activities of the individual components.

In the field of agriculture, it is often understood that the term “synergy” is as defined by Colby S. R. in an article entitled “Calculation of the synergistic and antagonistic responses of herbicide combinations” published in the journal Weeds, 1967, 15, p. 20-22, incorporated herein by reference in its entirety. The action expected for a given combination of two or three active components can be calculated as follows:

Colby's formula for calculating synergism between three active ingredients

$$E = ( X + Y + Z ) - ( {\underline{XY + XZ + YZ}}_{100} ) + ( {\underline{XYZ}}_{10000} )$$

Where, E=Expected % control by mixture/combination of Compound A, Compound B and Compound C in a defined dose
X=Observed % control by Compound A
Y=Observed % control by Compound B
Z=Observed % control by Compound C

Ratio=Observed Value (% control)/Expected Value (% control)

If ratio of O/E>1, means synergism observed, O/E<1, means antagonism, O/E=1, means additive reaction

Colby's formula for calculating synergism between two active ingredient

$$E = X + Y - \frac{XY}{100}$$

Where,
E=Expected % control by mixture/combination of Compound A and Compound B in a defined dose
X=Observed % control by Compound A
Y=Observed % control by Compound B

$$Ratio = \frac{Observed value ( \% control )}{Expected value ( \% control )}$$

Ratio of O/E>1, means synergism observed, O/E>1, means antagonism, O/E=1, means additive effect

### Experiment 1: Bio-Efficacy and Residual Control Provided by Novel OD Formulations of Spinetoram+Insecticide

Crop: Chilly
Insects: Thrips, Scirtothrips dorsalis
Location: Umreth, Dist. Anand, Gujarat
Treatments: 14
Plot size: 30 sq.m.
Crop age: 60 days after transplanting.
Spray water volume: 400 liter per hectare
Method of Application: Foliar spray with battery operated knapsack sprayer fitted with hollow cone nozzle.
Agronomic Practices: Except insecticidal applications, all agronomic practices followed as per the crop requirement.

### Observation Methods:

Thrips (Scirtothrips dorsalis) control (%): Count the number of insects per twig by gently shaking the twig over black piece of paper. Record observations from such 3 twigs per plant and 10 plants per plot at 3, 7, 10 and 14 DAA (Days after application).

Calculate % insect control (Observed value) by given formula.

$$\% Insect control = 100 - \frac{Number of live insects in treatment}{Number of live insects in untreated} \times 100$$

Apply Colby's formula to study the synergism.

TABLE 1
Treatment details

| Treat- | | User |
|---|---|---|
| ment | | rate |
| Number | Treatment details | (gai/h) |
| T1 | Spinetoram 4% + Tolfenpyrad 12% OD (Novel | 25 + 75 |
| | OD) | |
| T2 | Spinetoram 4% + Abamectin 0.9% OD (Novel | 25 + 5.625 |
| | OD) | |
| T3 | Spinetoram 4% + Emamectin benzoate 0.9% | 25 + 5.625 |
| | OD (Novel OD) | |
| T4 | Spinetoram 4% + Tolfenpyrad 12% OD | 25 + 75 |
| | (conventional OD) | |
| T5 | Spinetoram 4% + Abamectin 0.9% OD | 25 + 5.625 |
| | (conventional OD) | |
| T6 | Spinetoram 4% + Emamectin benzoate 0.9% | 25 + 5.625 |
| | OD (conventional OD) | |
| T7 | Spinetoram 11.7% SC + Tolfenpyrad 15% EC | 25 + 75 |
| | (tank mix) | |
| T8 | Spinetoram 11.7% SC + Abamectin 1.9% EC | 25 + 5.625 |
| | (tank mix) | |
| T9 | Spinetoram 11.7% SC + Emamectin benzoate | 25 + 5.625 |
| | 1.9% EC (tank mix) | |
| T10 | Spinetoram 11.7% SC | 25 |
| T11 | Tolfenpyrad 15% EC | 75 |
| T12 | Abamectin 1.9% EC | 5.625 |
| T13 | Emamectin benzoate 1.9% EC | 5.625 |
| T14 | UTC (Untreated Check) | 0 |

TABLE 2
Synergistic and residual control of chilly thrips

| | Chilly Thrips control (%), Scirtothrips dorsalis | | | | | | | | | | | | | | | |
|---|---|---|---|---|---|---|---|---|---|---|---|---|---|---|---|---|
| | 3 DAA | | | | 7 DAA | | | | 10 DAA | | | | 14 DAA | | | |
| Treatment | | | | Syn | | | | Syn | | | | Syn | | | | Syn |
| Number | OV | EV | CR | (Y/N) | OV | EV | CR | (Y/N) | OV | EV | CR | (Y/N) | OV | EV | CR | (Y/N) |
| T1 | 98.8 | 82.83 | 1.19 | Y | 90.4 | 78.52 | 1.15 | Y | 80.2 | 68.20 | 1.18 | Y | 63.4 | 56.88 | 1.11 | Y |
| T2 | 90.2 | 79.15 | 1.14 | Y | 85.2 | 73.85 | 1.15 | Y | 76.4 | 66.55 | 1.15 | Y | 58.2 | 54.08 | 1.08 | Y |
| T3 | 88.6 | 76.17 | 1.16 | Y | 82.2 | 71.23 | 1.15 | Y | 73.4 | 63.13 | 1.16 | Y | 55.6 | 52.05 | 1.07 | Y |
| T4 | 92.2 | 82.83 | 1.11 | Y | 82.2 | 78.52 | 1.05 | Y | 67.8 | 68.20 | 0.99 | N | 55.2 | 56.88 | 0.97 | N |
| T5 | 86.2 | 79.15 | 1.09 | Y | 77.2 | 73.85 | 1.05 | Y | 66.2 | 66.55 | 0.99 | N | 51.8 | 54.08 | 0.96 | N |
| T6 | 82.4 | 76.17 | 1.08 | Y | 73.6 | 71.23 | 1.03 | Y | 62.8 | 63.13 | 0.99 | N | 49.6 | 52.05 | 0.95 | N |
| T7 | 86.8 | 82.83 | 1.05 | Y | 79.2 | 78.52 | 1.01 | Y | 66.2 | 68.20 | 0.97 | N | 49.8 | 56.88 | 0.88 | N |
| T8 | 82.4 | 79.15 | 1.04 | Y | 74.2 | 73.85 | 1.00 | Y | 64.8 | 66.55 | 0.97 | N | 47.6 | 54.08 | 0.88 | N |
| T9 | 79.6 | 76.17 | 1.04 | Y | 71.4 | 71.23 | 1.00 | Y | 61.0 | 63.13 | 0.97 | N | 44.2 | 52.05 | 0.85 | N |
| T10 | 56.2 | | | | 51.4 | | | | 44.8 | | | | 36.4 | | | |
| T11 | 60.8 | | | | 55.8 | | | | 42.4 | | | | 32.2 | | | |
| T12 | 52.4 | | | | 46.2 | | | | 39.4 | | | | 27.8 | | | |
| T13 | 45.6 | | | | 40.8 | | | | 33.2 | | | | 24.6 | | | |
| T14 | 0.0 | | | | 0.0 | | | | 0.0 | | | | 0.0 | | | |

OV-Observed Value, EV-Expected Value, CR-Colby's Ratio, Syn (Y/N)-Synergism (Yes/No), DAA-Days after application.

The field trials results on 3DAA shows novel OD formulations (T1,T2, T3) and conventional OD formulations (T4, T5, T6) and on farm tank mixes (T7, T8, T9) provides synergistic control of chilly thrips. Higher the value of CR (Colby's ratio) means stronger the synergism. At 3 DAA and 7 DAA, the novel OD formulations (T1,T2,T3) shows stronger synergism as compared to conventional OD formulation (T4,T5,T6). At 10 DAA and 14 DAA, only novel OD formulations (T1,T2,T3) provides synergistic control of chilly thrips, whereas conventional OD formulations (T4,T5,T6) and on farm tank mixes (T7,T8,T9) does not shows 10 synergism. The novel OD formulations (T1,T2,T3) provides excellent residual and synergistic control of chilly thrips as compared to conventional OD (T4,T5,T6) and on farm tank mixes (T7,T8,T9) treatments.

### Experiment 2: Bio-Efficacy of Novel OD Formulation of Spinetoram+Insecticide Against Red Gram Pod Borer

Crop: Red gram
Insects: Pod borer, Helicoverpa armigera larvae
Location: Dabhoi, Dist. Vadodara, Gujarat
Treatments: 23
Plot size: 25 sq.m.
Crop age: 96 days after transplanting.
Spray water volume: 500 liter per hectare
Method of Application: Foliar spray with battery operated knapsack sprayer fitted with hollow cone nozzle.
Agronomic Practices: Except insecticidal applications, all agronomic practices followed as per the crop requirement.

### Observation Methods:

Pod borer (Helicoverpa armigera) larval control (%): Count the number of live larvae per plant. Record the observations from 10 plants per plot on 3, 7 and 14 DAA. Calculate % larval control (Observed value) by given formula.

$$\% Insect control = 100 - \frac{Number of live insects in treatment}{Number of live insects in untreated} \times 100$$

Apply Colby's formula to study the synergism.

Pod count: Count the number of healthy (undamaged) per plant, 10 plants per plot on 14th day after application. Calculate % increase in healthy pods per plant.

$$Increase ( \% ) in pods over untreated control = \frac{100 \times Number of pods in treatment}{Number of pods in untreated} - 100$$

TABLE 3
Treatment details

| Treat- | | Use |
|---|---|---|
| ment | | Rate |
| Number | Treatment details | (gai/h) |
| T1 | Spinetoram 10% + Chlorantraniliprole 6% OD | 30 + 18 |
| | (Novel OD) | |
| T2 | Spinetoram 10% + Cyantraniliprole 10% OD (Novel | 30 + 30 |
| | OD) | |
| T3 | Spinetoram 10% + Tetraniliprole 8% OD (Novel | 30 + 24 |
| | OD) | |
| T4 | Spinetoram 10% + Broflanilide 2.5% OD (Novel | 30 + 7.5 |
| | OD) | |
| T5 | Spinetoram 10% + Fluxametamide 2.5% OD (Novel | 30 + 7.5 |
| | OD) | |
| T6 | Spinetoram 10% + Isocycloseram 10% OD (Novel | 30 + 30 |
| | OD) | |
| T7 | Spinetoram 10% + Dichloromezotiaz 7.5% OD | 30 + 22.5 |
| | (Novel OD) | |
| T8 | Spinetoram 11.7% SC + Chlorantraniliprole 20% | 30 + 18 |
| | SC (tank mix) | |
| T9 | Spinetoram 11.7% SC + Cyantraniliprole 10% OD | 30 + 30 |
| | (tank mix) | |
| T10 | Spinetoram 11.7% SC + Tetraniliprole 20% SC | 30 + 24 |
| | (tank mix) | |
| T11 | Spinetoram 11.7% SC + Broflanilide 20% SC | 30 + 7.5 |
| | (tank mix) | |
| T12 | Spinetoram 11.7% SC + Fluxametamide 10% L | 30 + 7.5 |
| | (tank mix) | |
| T13 | Spinetoram 11.7% SC + Isocycloseram 10% DC | 30 + 30 |
| | (tank mix) | |
| T14 | Spinetoram 11.7% SC + Dichloromezotiaz 35% | 30 + 22.5 |
| | WG (tank mix) | |
| T15 | Spinetoram 11.7% SC | 30 |
| T16 | Chlorantraniliprole 20% SC | 18 |
| T17 | Cyantraniliprole 10% OD | 30 |
| T18 | Tetraniliprole 20% SC | 24 |
| T19 | Broflanilide 20% SC | 7.5 |
| T20 | Fluxametamide 10% L | 7.5 |
| T21 | Isocycloseram 10% DC | 30 |
| T22 | Dichloromezotiaz 35% WG | 22.5 |
| T23 | UTC (Untreated Check) | 0 |

TABLE 4
Synergistic larval control of Red gram pod borer

| | % Pod borer larval control | | | | | | | |
|---|---|---|---|---|---|---|---|---|
| | 3 DAA | | | | | | Number | % increase |
| Treatment | Obs. | Expected | Colby's | Synergism | 7 | 14 | of healthy | healthy |
| number | Value | Value | ratio | (Y/N) | DAA | DAA | pods/plant | pods |
| T1 | 99.2 | 86.36 | 1.15 | Y | 97.8 | 83.2 | 138.3 | 85.1 |
| T2 | 99.4 | 87.27 | 1.14 | Y | 96.6 | 83.8 | 141.5 | 89.4 |
| T3 | 99.2 | 84.52 | 1.17 | Y | 97.2 | 81.0 | 136.7 | 83.0 |
| T4 | 98.8 | 84.12 | 1.17 | Y | 96.4 | 80.6 | 140.4 | 88.0 |
| T5 | 99.4 | 83.73 | 1.19 | Y | 97.4 | 80.2 | 134.5 | 80.1 |
| T6 | 99.6 | 85.31 | 1.17 | Y | 95.8 | 81.4 | 135.3 | 81.1 |
| T7 | 98.8 | 87.14 | 1.13 | Y | 96.6 | 81.8 | 136.4 | 82.6 |
| T8 | 91.4 | 86.36 | 1.06 | Y | 84.6 | 73.8 | 122.8 | 64.4 |
| T9 | 90.8 | 87.27 | 1.04 | Y | 85.2 | 74.6 | 124.2 | 66.3 |
| T10 | 90.2 | 84.52 | 1.07 | Y | 81.6 | 69.2 | 121.2 | 62.2 |
| T11 | 89.4 | 84.12 | 1.06 | Y | 82.8 | 68.4 | 122.5 | 64.0 |
| T12 | 88.4 | 83.73 | 1.06 | Y | 81.6 | 68.2 | 114.8 | 53.7 |
| T13 | 87.6 | 85.31 | 1.03 | Y | 82.2 | 70.2 | 117.5 | 57.3 |
| T14 | 89.8 | 87.14 | 1.03 | Y | 84.4 | 72.2 | 120.6 | 61.4 |
| T15 | 67.2 | | | | 63.8 | 54.8 | 102.4 | 37.1 |
| T16 | 58.4 | | | | 55.2 | 46.2 | 100.6 | 34.7 |
| T17 | 61.2 | | | | 57.2 | 47.8 | 99.4 | 33.1 |
| T18 | 52.8 | | | | 46.2 | 36.4 | 97.6 | 30.7 |
| T19 | 51.6 | | | | 45.8 | 35.8 | 101.2 | 35.5 |
| T20 | 50.4 | | | | 44.4 | 35.2 | 98.2 | 31.5 |
| T21 | 55.2 | | | | 49.6 | 39.2 | 97.5 | 30.5 |
| T22 | 60.8 | | | | 53.8 | 43.8 | 100.5 | 34.5 |
| T23 | 0.0 | | | | 0.0 | 0.0 | 74.7 | 0.0 |

The field trial results shows all the novel OD formulations (T1,T2,T3, T4, T5, T6, T7) treatments provides very strong synergistic control of red gram pod borer larval control and excellent residual control up to 14 days. The on farm tank mixes treatments (T8,T9,T10,T11,T12,T13, T14) also provides the synergistic(with weak Colby's ratio) larval control on 3rd day and 7th day but that synergism does not exist on 14^{th} day and does not contributing the residual control. The novel OD formulations treatments shows >80% increase in healthy pod count, whereas on farm tank mix treatments shows maximum 66% increase in healthy pod count over the untreated control.

### Experiment 3: To Study the Impact of Different Dosages on Bio-Efficacy and Residual Control Provided by Novel OD Formulations Vs Conventional OD Formulations Against Sucking Pests Infesting Cotton Crop

Crop: Cotton
Insects: Thrips (Thrips tabaci)
Location: Dabhoi, Dist. Baroda, Gujarat
Treatments: 11
Plot size: 50 sq.m.
Crop age: 62 days after sowing.
Spray water volume: 380 liter per hectare
Method of Application: Foliar spray with battery operated knapsack sprayer fitted with hollow cone nozzle.
Agronomic Practices: All agronomic practices followed as per the crop requirement, except insecticidal application.

### Observation Methods:

Insect control (%)—Count the number of live insects (thrips) per leaf. Record the observations from 3 leaves per plant and 10 plants per plot on 2, 5 and 10 days after application (DAA).

Calculate % insect control by below formula.

$$\% Insect control = 100 - \frac{Number of live insects in treatment}{Number of live insects in untreated} \times 100$$

TABLE 5
Treatment details (cotton thrips)

| | | Use |
|---|---|---|
| Treatment | | Rate |
| Number | Treatment details | (gai/h) |
| T1 | Spinetoram 4% + Diafenthiuron 24% OD (Novel | 25 + 150 |
| | OD-Lower dose) | |
| T2 | Spinetoram 4% + Diafenthiuron 24% OD (Novel | 30 + 180 |
| | OD-Higher dose) | |
| T3 | Spinetoram 4% + Diafenthiuron 24% OD | 25 + 150 |
| | (Conventional OD-Lower dose) | |
| T4 | Spinetoram 4% + Diafenthiuron 24% OD | 30 + 180 |
| | (Conventional OD-Higher dose) | |
| T5 | Spinetoram 11.7% SC + Diafenthiuron 50% WP | 25 + 150 |
| | (Lower dose-tank mix) | |
| T6 | Spinetoram 11.7% SC + Diafenthiuron 50% WP | 30 + 180 |
| | (Higher dose-tank mix) | |
| T7 | Spinetoram 11.7% SC | 25 |
| T8 | Spinetoram 11.7% SC | 30 |
| T9 | Diafenthiuron 50% WP | 150 |
| T10 | Diafenthiuron 50% WP | 180 |
| T11 | UTC (Untreated Check) | 0 |

TABLE 6
Control Cotton thrips

| | | | | Drop (%) in efficacy due | | |
|---|---|---|---|---|---|---|
| Treatment | Thrips control (%) | | | to dose reduction | | |
| Number | 2 DAA | 5 DAA | 10 DAA | 2 DAA | 5 DAA | 10 DAA |
| T1 | 83.8 | 78.6 | 68.4 | 4.6 | 5.1 | 7.1 |
| T2 | 87.8 | 82.8 | 73.6 | | | |
| T3 | 83.2 | 75.8 | 64.4 | 5.2 | 8.5 | 12.5 |
| T4 | 87.8 | 82.8 | 73.6 | | | |
| T5 | 77.6 | 67.6 | 49.2 | 7.0 | 11.3 | 25.9 |
| T6 | 83.4 | 76.2 | 66.4 | | | |
| T7 | 54.8 | 48.0 | 35.4 | | | |
| T8 | 62.4 | 57.2 | 46.8 | | | |
| T9 | 50.2 | 43.0 | 31.8 | | | |
| T10 | 54.4 | 48.6 | 47.8 | | | |
| T11 | 0.0 | 0.0 | 0.0 | | | |

The field trial results on bio efficacy against cotton thrips shows that when dose of novel OD formulation reduce from 750 ml/h (T2) to 625 ml/h (T1), the efficacy for thrips control drops by 4.6%, 5.1% and 7.1% on 2nd, 5th and 10th DAA respectively, where as dose of conventional OD formulation reduce from 750 ml/h (T4) to 625 ml/h (T3), the efficacy for thrips control drops by 5.2%, 8.5% and 12.5% on 2nd, 5th and 10th DAA respectively. The efficacy of on farm tank mixes (T6 to T5) drops drastically on 5^{th} and 10^{th} DAA. This means with the novel OD formulation we can optimize the dose and reduce the a.i. loading into the environment. Novel OD formulation of Spinetoram+Diafenthiuron is more stable, higher efficacious and consistent in efficacy.

### Experiment 4: Bio Efficacy of Novel OD Formulation Against Chilly Sucking Pests

Crop: Chilly
Insects: Thrips (Scirtothrips dorsalis), Yellow mite (Polyphagotarsonemus latus)
Location: Umreth, Dist. Anand, Gujarat
Treatments: 12
Plot size: 40 sq.m.
Crop age: 65 days after sowing.
Spray water volume: 450 liter per hectare Method of Application: Foliar spray with battery operated knapsack sprayer fitted with hollow cone nozzle. Apply 2 spray at 10 days interval to assess the impact on fruit yield.
Agronomic Practices: All agronomic practices followed as per the crop requirement, except insecticidal application.

### Observation Methods:

Thrips (Scirtothrips dorsalis) control (%): Count the number of insects per twig by gently shaking the twig over black piece of paper. Record observations from such 3 twigs per plant and 10 plants per plot on 5th DAA (Days after application).

Mite (Polyphagotarsonemus latus) control (%): Count the number of motile stage of mite per microscopic field from 3 spot per leaf, 3 leaves per plant and 10 plants per plot. Calculate % insect control (Observed value) by given formula.

$$\% Insect control = 100 - \frac{Number of live insects in treatment}{Number of live insects in untreated} \times 100$$

Apply Colby's formula to calculate synergism.

Fruit count: Count the number of healthy and marketable green fruits per plant and 10 plants per plot. Record the observations on 10th day after second spray. Recalculate the increase (%) in healthy fruits over untreated control.

$$Increase ( \% ) in fruits over untreated control = \frac{100 \times Number of fruits in treatment}{Number of fruits in untreated} - 100$$

TABLE 7
Treatment details (Chilly-Thrips and mites)

| Treat- | | Use |
|---|---|---|
| ment | | Rate |
| Number | Treatment details | (gai/h) |
| T1 | Spinetoram 8% + lambda cyhalothrin 5% OD | 40 + 25 |
| | (Novel OD) | |
| T2 | Spinetoram 8% + Fenpyroximate 5% OD (Novel OD) | 40 + 25 |
| T3 | Spinetoram 8% + Hexythiazox 5% OD (Novel OD) | 40 + 25 |
| T4 | Spinetoram 8% + Etoxazole 6% OD (Novel OD) | 40 + 30 |
| T5 | Spinetoram 8% + Cyenopyrafen 10% OD (Novel | 40 + 50 |
| | OD) | |
| T6 | Spinetoram 11.7% SC | 40 |
| T7 | Lambda cyhalothrin 5% EC | 25 |
| T8 | Fenpyroximate 5% SC | 25 |
| T9 | Hexythiazox 5% SC | 25 |
| T10 | Etoxazole 10% SC | 30 |
| T11 | Cyenopyrafen 30% SC | 40 |
| T12 | UTC (Untreated Check) | 0 |

TABLE 8
Synergistic control of Chilly thrips and mites

| | Thrips control (%) | | | Yellow mite control (%) | | | | % increase |
|---|---|---|---|---|---|---|---|---|
| Treatment | Obs. | Cal. | Colby's | Obs. | Cal. | Colby's | Synergism | in fruits |
| Number | Value | Value | ratio | Value | Value | ratio | (Y/N) | per plant |
| T1 | 95.2 | 88.85 | 1.07 | 77.4 | 73.10 | 1.06 | Y | 51.2 |
| T2 | 92.4 | 86.12 | 1.07 | 78.8 | 69.91 | 1.13 | Y | 45.3 |
| T3 | 91.6 | 87.25 | 1.05 | 85.2 | 75.01 | 1.14 | Y | 40.2 |
| T4 | 90.4 | 85.14 | 1.06 | 88.6 | 76.28 | 1.16 | Y | 40.8 |
| T5 | 91.2 | 85.50 | 1.07 | 84.4 | 74.05 | 1.14 | Y | 41.4 |
| T6 | 74.2 | | | 20.4 | | | | 26.3 |
| T7 | 56.8 | | | 66.2 | | | | 23.1 |
| T8 | 46.2 | | | 62.2 | | | | 22.7 |
| T9 | 50.6 | | | 68.6 | | | | 20.3 |
| T10 | 42.4 | | | 70.2 | | | | 19.8 |
| T11 | 43.8 | | | 67.4 | | | | 18.6 |
| T12 | 0.0 | | | 0.0 | | | | 0.0 |

All the ready mix novel OD formulations of Spinetoram+Insecticide (T1,T2,T3, T4, T5) provides the synergistic control of chilly thrips and mites and also yielded higher number of marketable green chilly fruits.

### Experiment 5: Control of Sucking Pests Infesting Cotton Crop

Crop: Cotton
Insects: Thrips (Thrips tabaci), Jassid (Amrasca biguttula biguttula)
Location: Rajkot, Gujarat
Treatments: 14
Plot size: 50 sq.m.
Crop age: 55 days after sowing.
Spray water volume: 350 liter per hectare
Method of Application: Foliar spray with battery operated knapsack sprayer fitted with hollow cone nozzle.
Agronomic Practices: All agronomic practices followed as per the crop requirement, except insecticidal application.

### Observation Methods:

Insect control (%)—Count the number of live insects (thrips and jassid separately) per leaf. Record the observations from 3 leaves per plant and 10 plants per plot on 5th days after application (DAA).

Calculate % insect control (observed value) by below formula.

$$\% Insect control = 100 - \frac{Number of live insects in treatment}{Number of live insects in untreated} \times 100$$

Apply Colby's formula to calculate synergism.

TABLE 9
Treatment details (Cotton sucking pests)

| Treat- | | Use |
|---|---|---|
| ment | | Rate |
| Number | Treatment details | (gai/h) |
| T1 | Spinetoram 4% + Diafenthiuron 24% OD (Novel | 40 + 240 |
| | OD) | |
| T2 | Spinetoram 8% + Flonicamid 10% OD (Novel OD) | 40 + 50 |
| T3 | Spinetoram 8% + Fipronil 8% OD (Novel OD) | 40 + 40 |
| T4 | Spinetoram 8% + Spiropidion 8% OD (Novel OD) | 40 + 40 |
| T5 | Spinetoram 8% + Dimpropyridaz 8% OD (Novel | 40 + 40 |
| | OD) | |
| T6 | Spinetoram 8% + Clothianidin 12% OD (Novel | 40 + 60 |
| | OD) | |
| T7 | Spinetoram 11.7% SC | 40 |
| T8 | Diafenthiuron 50% WP | 240 |
| T9 | Flonicamid 50% WG | 50 |
| T10 | Fipronil 5% SC | 40 |
| T11 | Spiropidion 10% SC | 40 |
| T12 | Dimpropyridaz 12% SC | 40 |
| T13 | Clothianidin 50% WDG | 60 |
| T14 | UTC (Untreated Check) | 0 |

TABLE 10
Bio efficacy of Novel OD formulations of Spinetoram +
Insecticide against sucking pests infesting cotton crop

| | | | | | | | | % increase |
|---|---|---|---|---|---|---|---|---|
| | Thrips control (%) | | | Jassid control (%) | | | | in fruiting |
| Treatment | Obs. | Cal. | Colby's | Obs. | Cal. | Colby's | Synergism | bodies |
| Number | Value | Value | ratio | Value | Value | ratio | (Y/N) | per plant |
| T1 | 98.4 | 88.63 | 1.11 | 70.2 | 65.46 | 1.07 | Y | 64.5 |
| T2 | 96.4 | 86.45 | 1.12 | 93.6 | 85.11 | 1.10 | Y | 61.2 |
| T3 | 99.2 | 90.15 | 1.10 | 75.2 | 69.44 | 1.08 | Y | 56.8 |
| T4 | 98.2 | 89.77 | 1.09 | 88.4 | 77.27 | 1.14 | Y | 63.6 |
| T5 | 97.6 | 89.34 | 1.09 | 85.6 | 76.12 | 1.12 | Y | 60.2 |
| T6 | 96.2 | 85.53 | 1.12 | 87.2 | 77.79 | 1.12 | Y | 50.3 |
| T7 | 72.8 | | | 35.8 | | | | 30.4 |
| T8 | 58.2 | | | 46.2 | | | | 32.6 |
| T9 | 50.2 | | | 76.8 | | | | 28.6 |
| T10 | 63.8 | | | 52.4 | | | | 25.7 |
| T11 | 62.4 | | | 64.6 | | | | 31.7 |
| T12 | 60.8 | | | 62.8 | | | | 33.5 |
| T13 | 46.8 | | | 65.4 | | | | 21.8 |
| T14 | 0.0 | | | 0.0 | | | | 0.0 |

All the ready mix novel OD formulations of Spinetoram+Insecticide (T1,T2,T3,T4,T5,T6) provides the synergistic control of cotton thrips and jassid and also produces higher number of fruiting bodies (square, flowers and bolls).

### Experiment 6: Study of Rain Fastness Properties of Novel OD Formulation of Spinetoram+Insecticide

Crop & Variety: Marigold, Lemon shade
Location: Umreth, Dist. Anand, Gujarat
Treatments: 6
Plot size: 50 sq.m.
Crop age: 62 days after transplanting.
Spray water volume: 450 liter per hectare
Method of Application: Foliar spray with battery operated knapsack sprayer fitted with hollow cone nozzle.
Agronomic Practices: Except fungicidal applications, all agronomic practices followed as per the crop requirement.

### Methods for Rain Fastness Study:

The treatment application (spraying) was done knap sack sprayer by using 450 liter spray volume. After 60 minutes of spraying, artificial raining was done through overhead sprinkler system in trial plot for 30 minutes which was approximately equal to 10 mm of rainfall (measured by rain gauge).

Thrips (Thrips tabaci) control (%): The observations was recorded before the spray and 1, 3, 7, 10 and 14 days after the spray. Count the number of thrips per flower by gentle shaking the flower on black piece of paper. Record the observations from 20 flower randomly selected covering entire plot. Calculate % thrips control as given in experiment 1.

TABLE 11
Treatment details

| | | Use |
|---|---|---|
| Treatment | | Rate |
| Number | Treatment details | (gai/h) |
| T1 | Spinetoram 4% + Tolfenpyrad 12% OD | 25 + 75 |
| | (Novel OD) | |
| T2 | Spinetoram 4% + Tolfenpyrad 12% OD | 25 + 75 |
| | (Conventional OD) | |
| T3 | Spinetoram 11.7% SC + Tolfenpyrad 15% EC | 25 + 75 |
| | (tank mix) | |
| T4 | Spinetoram 11.7% SC | 25 |
| T5 | Tolfenpyrad 15% EC | 75 |
| T6 | UTC (Untreated Check) | 0 |

TABLE 12
Rain fast action of Novel OD formulation of Spinetoram + Tolfenpyrad

| | Precount | | | | | |
|---|---|---|---|---|---|---|
| Treatment | (Number of | Thrips control (%) | | | | |
| Number | thrips per flower) | 1 DAA | 3 DAA | 7 DAA | 10 DAA | 14 DAA |
| T1 | 62.8 | 99.2 | 94.2 | 85.2 | 77.4 | 65.2 |
| T2 | 59.4 | 95.8 | 86.2 | 74.6 | 60.2 | 47.2 |
| T3 | 65.8 | 92.4 | 82.8 | 68.4 | 51.4 | 33.4 |
| T4 | 60.2 | 62.8 | 57.6 | 42.8 | 23.4 | 5.6 |
| T5 | 58.4 | 64.8 | 58.2 | 43.2 | 22.6 | 4.2 |
| T6 | 63.2 | 0.0 | 0.0 | 0.0 | 0.0 | 0.0 |

The novel OD formulation of Spinetoram+Tolfenpyrad provides excellent control of marigold flower thrips up to 14 days, as compared to their conventional OD formulation and tank mix.

### SUMMARY AND CONCLUSION

Novel OD formulations of Spinetoram+Insecticide provides higher efficacy compared to conventional OD formulation and their tank mixes.
Novel OD formulations of Spinetoram+Insecticide provide better efficacy at reduced dosages in comparison with conventional OD formulation, so we can reduce the active ingredients application rate and their by lowering the loading of active ingredients into the crop ecosystem.
Novel OD formulations of Spinetoram+Insecticide shows excellent rain fast action. This is very useful during the rainy season.
Novel OD formulations of Spinetoram+Insecticide observed safe to the crop and does not have any kind of phytotoxicity symptoms.
Novel OD formulation of Spinetoram+Insecticide produces higher number of fruits, flowers, square, bolls and there by yield of the treated crops.

We claim:

1. A synergistic Oil Dispersion agrochemical composition comprising:
a. Spinetoram present in amount of 2%-20% by weight;
b. at least one more active ingredient is selected from class of an insecticide; or a fungicide; or a plant health additive; or
combination thereof present in amount of 0.1%-30% by weight;
c. super wetting-spreading-penetrating agent present in amount of 1% to 10% by weight;
d. carrier or solvent present selected from pongamia oil or palm oil or jojoba oil or combination thereof or blend with vegetable oil in amount of 10% to 80% by weight; and
e. at least one formulation excipient.

2. The synergistic Oil Dispersion agrochemical composition as claimed in claim 1, wherein formulation excipient is selected from
a) cosolvent present in amount of 2%-15% by weight;
b) emulsifying agent present in amount of 5%-30% by weight;
c) dispersing agent present in amount of 1%-20% by weight;
d) stabilizer present in amount of 0.1%-4% by weight;
e) antifoaming agent present in amount of 0.01%-2% by weight;
f) preservative present in amount of 0.1%-4% by weight;
g) anti-freezing agent present in amount of 0.5%-10% by weight;
h) buffering agents present in amount of 0.1%-4% by weight.

3. The synergistic Oil Dispersion agrochemical composition as claimed in claim 1, wherein combination of active ingredient is selected from Spinetoram+Insecticide; Spinetoram+Insecticide A+Insecticide B; Spinetoram+Fungicide; Spinetoram+Fungicide A+Fungicide B; Spinetoram+Plant Health Additive; Spinetoram+Insecticide+Plant Health Additive; Spinetoram+Fungicide+Plant Health Additive; Spinetoram+Insecticide+Fungicide.

4. The synergistic Oil Dispersion agrochemical composition as claimed in claim 1, wherein an insecticide is selected from class of Carbamates; Organophosphates; Phenylpyrazole; Pyrethroids; Nicotinic insecticides; Mectins; Juvenile hormone mimics; Chordotonal organs modulators; Mite growth inhibitors; Microbial disruptors of insect midgut membrane; Inhibitors of mitochondrial ATP synthase; Uncouplers of oxidative phosphorylation; Chitin biosynthesis inhibitors; Inhibitors of the chitin biosynthesis type 1; Moulting disruptors; Ecdyson receptor agonists; Octopamin receptor agonists; METI (mitochondrial electron transport inhibitors; Voltage-dependent sodium channel blockers; Inhibitors of the lipid synthesis, inhibitors of acetyl COA carboxylase; Diamides; Metadiamides; Isoxazolines; Baculoviruses; compounds of unknown or uncertain mode of action.

5. The synergistic Oil Dispersion agrochemical composition as claimed in claim 1, wherein a fungicide compound is selected from class of Nucleic acid synthesis inhibitors; Cytoskeleton and motor proteins/cell division Inhibitors; Respiration inhibitors; Amino acids and protein synthesis inhibitors; Signal transduction inhibitors; Lipid or transport and membrane synthesis inhibitors; Sterol biosynthesis Inhibitors; Cell wall biosynthesis Inhibitors; Melanin synthesis in cell wall Inhibitors; Plant defence inducers; Unknown mode of action; Not classified (N); Chemicals with multisite activities (M)-multisite contact activities; Biologicals with multiple modes of action (BM); others.

6. The synergistic Oil Dispersion agrochemical composition as claimed in claim 1, wherein plant health additives are selected from bio-stimulants, plant growth regulators, microbial agents and micronutrients or mixture thereof.

7. (canceled)

8. The synergistic Oil Dispersion agrochemical composition as claimed in claim 1, wherein super wetting-spreading-penetrating agent is Polyalkyleneoxide modified Heptamethyl trisiloxane (Modified trisiloxane) present in an amount of 1% to 10% by weight.

9. The synergistic Oil Dispersion agrochemical composition as claimed in claim 1, wherein oil phase as a carrier/solvent is selected from pongamia oil; or palm oil; or pongamia oil and palm oil; or pongamia oil and jojoba oil; or palm oil and jojoba oil; or pongamia oil and vegetable oil; or palm oil and vegetable oil; or pongamia oil and palm oil and vegetable oil; and it may be alkylated or ethoxylated or epoxylated or esterified.

10. The synergistic Oil Dispersion agrochemical composition as claimed in claim 1, wherein vegetable oil may be selected from one or mixture of two or more selected from soybean (Glycine max) oil, groundnut (Arachis hypogaea) oil, rapeseed (Brassica napus subspecies) oil, mustard (Brassica juncea) oil, sesame (Sesamum indicum) oil, Corn (Zea mays) oil, rice (Oryza sativa) bran oil, castor (Ricinum communis) seed oil, cotton (Gossypium hirsutum) seed oil, linseed (Linum usitatissimum), coconut (Cocos nucifera) oil, Kapok (Ceiba pentandra) oil, Papaya (Carica papaya) seed oil, Tea seed (Camellia oleifera) oil, sunflower (Helianthus annuus) oil, safflower (Carthamus tinctorius) seed oil, Eucalyptus (Eucalyptus globulus) oil, Olive (Olea europaea) oil, Jatropha (Jatropha curcas) oil, Garlic acid (Allium sativum), Ginger oil (Zingiber officinale), D-limonene, Citronella oil or Ceylon ironwood (Mesua ferrea) oil, Mahua (Madhuca longifolia) oil.

11. The synergistic Oil Dispersion agrochemical composition as claimed in claim 1, wherein cosolvent is selected from Cyclohexanone, Acetophenone, NMP (N-methyl pyrrolidinone), Dimethyl sulfoxide, Benzyl alcohol, Butanol, N-octanol, N-Propanol, 2-ethyl hexanol, Tetrahydro furfuryl alcohol, Isophorone, Fatty acid dimethyl amide, 2-hexylethyl lactate, Propylene carbonate.

12. The synergistic Oil Dispersion agrochemical composition as claimed in claim 1, wherein an emulsifying agent is selected from castor oil ethoxylates, alcohol ethoxylates, fatty acid ethoxylates, sorbitan ester ethoxylates, sulphosuccinate, calcium salts of dodecylbenzene sulphonate, alkylammonium salts of alkylbenzene sulphonate, alkylsulphosuccinate salts, ethylene oxide-propylene oxide block copolymers, ethoxylated alkylamines, ethoxylated alkyl phenols, polyoxyethylene sorbitan monolaurate.

13. The synergistic Oil Dispersion agrochemical composition as claimed in claim 1, wherein dispersing agent is selected from Preparation of condensed naphthalene sulfonate, Propoxylated Ethoxylated copolymer monoalkylether (ethylhexanol), alkyl sulfonates, alkyl benzene sulfonates, alkyl aryl sulfonates, alkylphenolalkoxylates, tristyrylphenol ethoxylates, natural or synthetic fatty ethoxylate alcohols, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers), fatty acid-polyalkylene glycol condensates, polyamine-fatty acid condensates, polyester condensates, salts of polyolefin condensates, sodium ligno sulfonate, sodium ploycarboxylate, EO/PO based copolymer, phenol sulfonate, sodium methyl oleoyl taurate, acrylic copolymer blend, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide.

14. The synergistic Oil Dispersion agrochemical composition as claimed in claim 1, wherein stabilizer is selected from hectorite clay, aluminium magnesium silicate, bentonite clay, silica, silicon dioxide, attapulgite clay.

15. The synergistic Oil Dispersion agrochemical composition as claimed in claim 1, wherein antifoaming agent is selected from silicone oil, silicone compound, C10˜C20 saturated fat acid compounds or C8˜C10 aliphatic alcohols compound, silicone antifoam emulsion, dimethylsiloxane, polydimethyl siloxane, vegetable oil based antifoam, tallow based fatty acids, polyalkyleneoxide modified polydimethylsiloxane.

16. The synergistic Oil Dispersion agrochemical composition as claimed in claim 1, wherein anti-freezing agent is selected from ethylene glycol, propane diols, glycerine or the urea, glycol (Monoethylene glycol, Diethylene glycol, Propylene glycol, Polypropylene glycol, Polyethylene glycol), glycerine, urea, magnesium sulfate heptahydrate, sodium chloride.

17. The synergistic Oil Dispersion agrochemical composition as claimed in claim 1, wherein Preservative is selected from 1,2-benzisothiazolin-3(2H)-one, sodium salt, sodium benzoate, 2-bromo-2-nitropropane-1,3-diol, formaldehyde, sodium o-phenylphenate, 5-chloro-2-methyl-4-isothiazolin-3-one & 2-methyl-4-isothiazolin-3-one, Butyl hydroxyl toluene.

18. The synergistic Oil Dispersion agrochemical composition as claimed in claim 1, wherein buffering agent is selected Citric acid, sodium carbonate, sodium bicarbonate, sulphuric acid, hydrochloric acid, sodium hydroxide, potassium hydroxide, acetic acid, sorbic acid.
